(19) United States
(12) Patent Application Publication
(10) Pub. No.: US 2024/0365376 A1
(43) Pub. Date: Oct. 31, 2024

(54) NETWORK NODES, SYSTEMS, METHODS, CIRCUITRY AND COMPUTER PROGRAM PRODUCTS

(71) Applicant: Sony Group Corporation, Tokyo (JP)

(72) Inventors: Shin Horng WONG, Basingstoke (GB); Naoki KUSASHIMA, Basingstoke (GB); Martin Warwick BEALE, Basingstoke (GB); Yassin Aden AWAD, Basingstoke (GB)

(73) Assignee: Sony Group Corporation, Tokyo (JP)

(21) Appl. No.: 18/291,224

(22) PCT Filed: Jul. 12, 2022
(86) PCT No.: PCT/EP2022/069475

§ 371 Date: Jan. 23, 2024

(30) Foreign Application Priority Data
Aug. 2, 2021 (EP) 21189239.3

(51) Int. Cl. H04W 74/0808; H04W 72/0453

(52) U.S. Cl. CPC H04W 74/0808; H04W 72/0453

(57) ABSTRACT

A method for communicating in a mobile telecommunications network, the method comprising transmitting, by a first node and in a first transmission portion of a first frame, a grant message to a second node, the grant message scheduling a first transmission, wherein the grant message indicates that the first transmission will be transmitted in a later transmission portion of the first frames; performing, by the first network node, a first contention-based access procedure in respect of the later transmission portion; if the first contention-based access procedure is successful, the first node providing an indication that the later transmission portion was successfully acquired; monitoring, by the second node and based on the received grant, the indication; and determining, by the second node and based on whether the indication was detected, whether the first node successfully acquired the later transmission portion.

### FIELD

The present disclosure relates to Network nodes, systems, methods, circuitry and computer program products.

### BACKGROUND

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present invention.

Latest generation mobile telecommunication systems are able to support a wider range of services than simple voice and messaging services offered by earlier generations of mobile telecommunication systems. For example, with the improved radio interface and enhanced data rates provided by LTE systems, a user is able to enjoy high data rate applications such as mobile video streaming and mobile video conferencing that would previously only have been available via a fixed line data connection. The demand to deploy such networks is therefore strong and the coverage area of these networks, i.e. geographic locations where access to the networks is possible, is expected to continue to increase rapidly.

Future wireless communications networks will be expected to efficiently support communications with an ever-increasing range of devices and data traffic profiles than existing systems are optimised to support. For example, it is expected future wireless communications networks will be expected to efficiently support communications with devices including reduced complexity devices, machine type communication devices, high resolution video displays, virtual reality headsets and so on. Some of these different types of devices may be deployed in very large numbers, for example low complexity devices for supporting the “The Internet of Things”, and may typically be associated with the transmissions of relatively small amounts of data with relatively high latency tolerance.

In view of a desire to support new types of devices with a variety of applications there is expected to be a desire for future wireless communications networks, for example those which may be referred to as 5G or new radio (NR) systems/new radio access technology (RAT) systems, as well as future iterations/releases of existing systems, to efficiently support connectivity for a wide range of devices associated with different applications and different characteristic data traffic profiles and requirements.

One example of a new service is referred to as Ultra Reliable Low Latency Communications (URLLC) services which, as its name suggests, requires that a data unit or packet be communicated with a high reliability and with a low communications delay.

The increasing use of different types of network infrastructure equipment and terminal devices associated with different traffic profiles give rise to new challenges for efficiently handling communications in wireless communications systems that need to be addressed.

Example use cases currently considered to be of interest for next and latest generation wireless communication systems include so-called Ultra Reliable and Low Latency Communications (URLLC)/enhanced Ultra Reliable and Low Latency Communications (eURLLC). See, for example, the 3GPP documents RP-160671, “New SID Proposal: Study on New Radio Access Technology,” NTT DOCOMO, RAN #71 [1]; RP-172834, “Work Item on New Radio (NR) Access Technology,” NTT DOCOMO, RAN #78 [2]; RP-182089, “New SID on Physical Layer Enhancements for NR Ultra-Reliable and Low Latency Communication (URLLC),” Huawei, HiSilicon, Nokia, Nokia Shanghai Bell, RAN #81 [3]; and RP-190654, “Physical layer enhancements for NR ultra-reliable and low latency communication (URLLC),” Huawei, HiSilicon, RAN #89, Shenzhen, China, 18 to 21 Mar. 2019 [4].

Another example of a new service is Enhanced Mobile Broadband (eMBB) services, which are characterised by a high capacity with a requirement to support up to 20 Gb/s. URLLC and eMBB type services therefore represent challenging examples for both LTE type communications systems and 5G/NR communications systems, in particular to accommodate very different types of communication modes and services.

### SUMMARY

The invention is defined in the independent claims. Further example embodiments are provided in the dependent claims.

It is to be understood that both the foregoing general description and the following detailed description are illustrative, but are not restrictive, of the present technology. The described example devices, systems or methods of the present disclosure, together with associated teachings, will be best understood by reference to the following detailed description taken in conjunction with the accompanying drawings.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings wherein like reference numerals designate identical or corresponding parts throughout the several views, and wherein:

FIG. 1 schematically represents some aspects of an example LTE-type wireless telecommunication network;

FIG. 2 schematically represents some aspects of an example new radio (NR) access technology (RAT) wireless telecommunications network;

FIG. 3 schematically represents an example telecommunications system;

FIG. 4 schematically represents an example of a New Radio Unlicensed (NR-U) Channel Access on a grid of radio communications resources;

FIG. 5 schematically represents Type 1 and Type 2 Dynamic Channel Access on an uplink and downlink grid of radio communications resources;

FIG. 6 schematically represents example configurations for Type 2 Dynamic Channel Access on a grid of radio communications resources;

FIG. 7 schematically represents an example Fixed Frame Period;

FIG. 8 schematically represents an FFP configuration for a UE and an FFP configuration for a gNB;

FIGS. 9 and 10 schematically represent the scheduling of a transmission in a contention-based access system;

FIGS. 11 to 18 schematically represent the scheduling of a transmission in a contention-based access system where an indication is used to notify that the transmission portion of a frame has been acquired;

FIG. 19 illustrates an example method in a contention-based access system where an indication is used to notify that the transmission portion of a frame has been acquired.

In the following description, reference is made to the accompanying drawings which illustrate several examples of the present disclosure. It is to be understood that other examples may be implemented and system or method changes may be made without departing from the teachings of the present disclosure. The following detailed description is not to be taken in a limiting sense, and the scope of the present invention is defined only by the claims. It is to be understood that drawings are not necessarily drawn to scale.

### DESCRIPTION OF EXAMPLES

The invention is defined in the appended claims. The present disclosure includes example arrangements falling within the scope of the claims (and other arrangements may also be within the scope of the following claims) and may also include example arrangements that do not necessarily fall within the scope of the claims but which are then useful to understand the teachings and techniques provided herein.

### Long Term Evolution Advanced Radio Access Technology (4G)

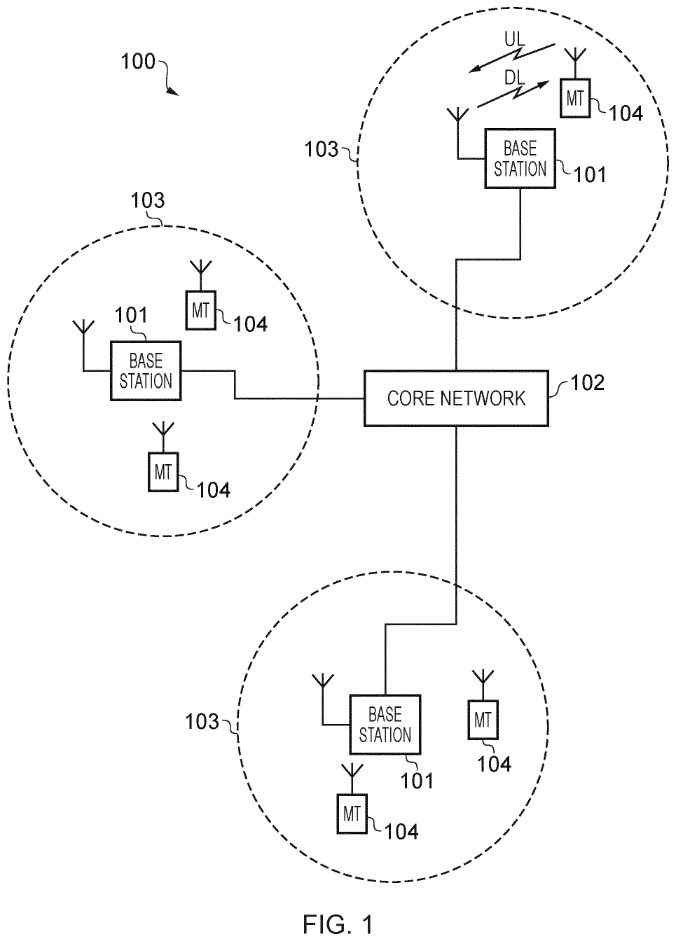

FIG. 1 provides a schematic diagram illustrating some basic functionality of a mobile telecommunications network/system 100 operating generally in accordance with LTE principles, but which may also support other radio access technologies, and which may be adapted to implement examples of the disclosure as described herein. Various elements of FIG. 1 and certain aspects of their respective modes of operation are well-known and defined in the relevant standards administered by the 3GPP (RTM) body, and also described in many books on the subject, for example, Holma H. and Toskala A [9]. It will be appreciated that operational aspects of the telecommunications (or simply, communications) networks discussed herein which are not specifically described (for example in relation to specific communication protocols and physical channels for communicating between different elements) may be implemented in accordance with any known techniques, for example according to the relevant standards and known proposed modifications and additions to the relevant standards.

The network 100 includes a plurality of base stations 101 connected to a core network 102. Each base station provides a coverage area 103 (i.e. a cell) within which data can be communicated to and from terminal devices 104. Data is transmitted from base stations 101 to terminal devices 104 within their respective coverage areas 103 via a radio downlink (DL). Data is transmitted from terminal devices 104 to the base stations 101 via a radio uplink (UL). The core network 102 routes data to and from the terminal devices 104 via the respective base stations 101 and provides functions such as authentication, mobility management, charging and so on. Terminal devices may also be referred to as mobile stations, user equipment (UE), user terminal, mobile radio, communications device, and so forth. Base stations, which are an example of network infrastructure equipment/network access node, may also be referred to as transceiver stations/nodeBs/e-nodeBs/eNBs/g-nodeBs/gNBs and so forth. In this regard different terminology is often associated with different generations of wireless telecommunications systems for elements providing broadly comparable functionality. However, certain examples of the disclosure may be equally implemented in different generations of wireless telecommunications systems, and for simplicity certain terminology may be used regardless of the underlying network architecture. That is to say, the use of a specific term in relation to certain example implementations is not intended to indicate these implementations are limited to a certain generation of network that may be most associated with that particular terminology.

### New Radio Access Technology (5G)

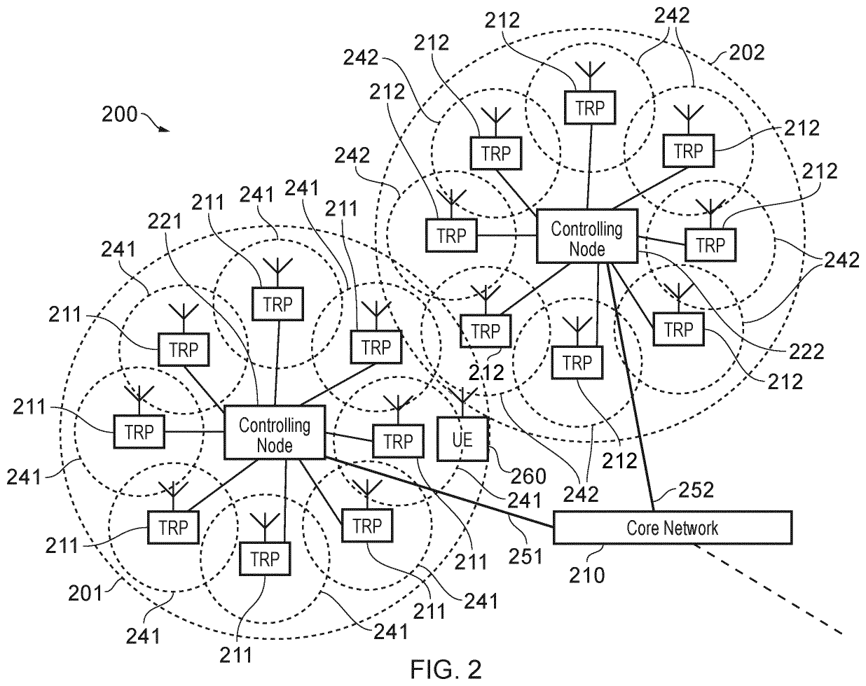

FIG. 2 is a schematic diagram illustrating a network architecture for a new RAT wireless communications network/system 200 based on previously proposed approaches which may also be adapted to provide functionality in accordance with examples of the disclosure described herein. The new RAT network 200 represented in FIG. 2 comprises a first communication cell 201 and a second communication cell 202. Each communication cell 201, 202, comprises a controlling node (centralised unit) 221, 222 in communication with a core network component 210 over a respective wired or wireless link 251, 252. The respective controlling nodes 221, 222 are also each in communication with a plurality of distributed units (radio access nodes/remote transmission and reception points (TRPs)) 211, 212 in their respective cells. Again, these communications may be over respective wired or wireless links. The distributed units (DUs) 211, 212 are responsible for providing the radio access interface for communications devices connected to the network. Each distributed unit 211, 212 has a coverage area (radio access footprint) 241, 242 where the sum of the coverage areas of the distributed units under the control of a controlling node together define the coverage of the respective communication cells 201, 202. Each distributed unit 211, 212 includes transceiver circuitry for transmission and reception of wireless signals and processor circuitry configured to control the respective distributed units 211, 212.

In terms of broad top-level functionality, the core network component 210 of the new RAT communications network represented in FIG. 2 may be broadly considered to correspond with the core network 102 represented in FIG. 1, and the respective controlling nodes 221, 222 and their associated distributed units/TRPs 211, 212 may be broadly considered to provide functionality corresponding to the base stations 101 of FIG. 1. The term network infrastructure equipment/access node may be used to encompass these elements and more conventional base station type elements of wireless communications systems. Depending on the application at hand the responsibility for scheduling transmissions which are scheduled on the radio interface between the respective distributed units and the communications devices may lie with the controlling node/centralised unit and/or the distributed units/TRPs.

A communications device or UE 260 is represented in FIG. 2 within the coverage area of the first communication cell 201. This communications device 260 may thus exchange signalling with the first controlling node 221 in the first communication cell via one of the distributed units 211 associated with the first communication cell 201. In some cases communications for a given communications device are routed through only one of the distributed units, but it will be appreciated in some other implementations communications associated with a given communications device may be routed through more than one distributed unit, for example in a soft handover scenario and other scenarios.

In the example of FIG. 2, two communication cells 201, 202 and one communications device 260 are shown for simplicity, but it will of course be appreciated that in practice the system may comprise a larger number of communication cells (each supported by a respective controlling node and plurality of distributed units) serving a larger number of communications devices.

It will further be appreciated that FIG. 2 represents merely one example of a proposed architecture for a new RAT communications system in which approaches in accordance with the principles described herein may be adopted, and the functionality disclosed herein may also be applied in respect of wireless communications systems having different architectures.

Thus examples of the disclosure as discussed herein may be implemented in wireless telecommunication systems/networks according to various different architectures, such as the example architectures shown in FIGS. 1 and 2. It will thus be appreciated the specific wireless communications architecture in any given implementation is not of primary significance to the principles described herein. In this regard, examples of the disclosure may be described generally in the context of communications between network infrastructure equipment/access nodes and a communications device, wherein the specific nature of the network infrastructure equipment/access node and the communications device will depend on the network infrastructure for the implementation at hand. For example, in some scenarios the network infrastructure equipment/access node may comprise a base station, such as an LTE-type base station 101 as shown in FIG. 1 which is adapted to provide functionality in accordance with the principles described herein, and in other examples the network infrastructure equipment/access node may comprise a control unit/controlling node 221, 222 and/or a TRP 211, 212 of the kind shown in FIG. 2 which is adapted to provide functionality in accordance with the principles described herein.

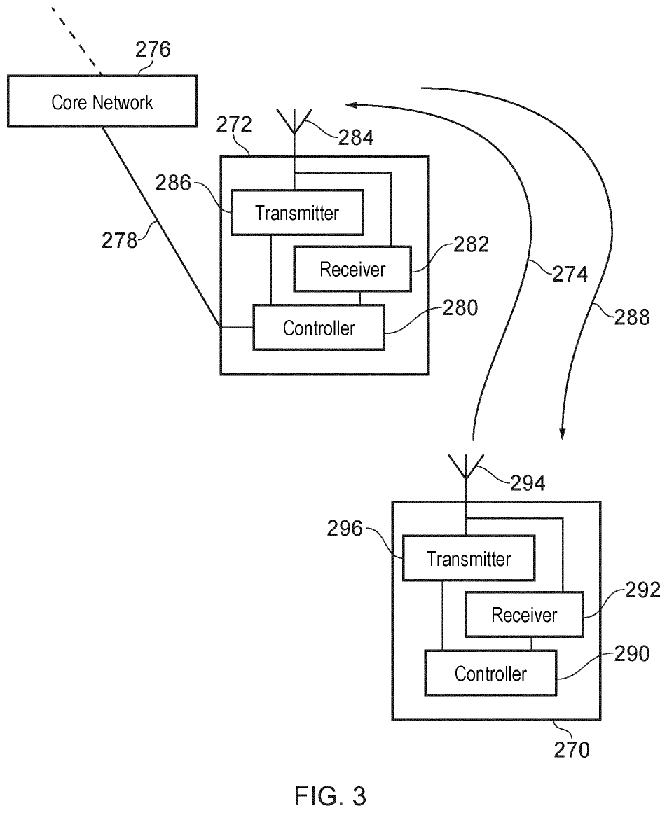

A more detailed illustration of a UE 270 and an example network infrastructure equipment 272, which may be thought of as a base station (e.g. an eNB) 101 or a combination of a controlling node 221 and TRP 211, is presented in FIG. 3. As shown in FIG. 3, the UE 270 is shown to receive downlink data from the infrastructure equipment 272 via resources of a wireless access interface as illustrated generally by an arrow 288 and to transmit uplink data to the infrastructure equipment 272 via resources of a wireless access interface as illustrated generally by an arrow 274. The UE 270 receives the downlink data transmitted by the infrastructure equipment 272 (or sends the uplink data to the infrastructure equipment 272) via communications resources of the wireless access interface (not shown). As with FIGS. 1 and 2, the infrastructure equipment 272 is connected to a core network 276 via an interface 278 to a controller 280 of the infrastructure equipment 272. The infrastructure equipment 272 includes a receiver 282 connected to an antenna 284 and a transmitter 286 connected to the antenna 284. Correspondingly, the UE 270 includes a controller 290 connected to a receiver 292 which receives signals from an antenna 294 and a transmitter 296 also connected to the antenna 294.

The controller 280 is configured to control the infrastructure equipment 272 and may comprise processor circuitry which may in turn comprise various sub-units/sub-circuits for providing functionality as explained further herein. These sub-units may be implemented as discrete hardware elements or as appropriately configured functions of the processor circuitry. Thus the controller 280 may comprise circuitry which is suitably configured/programmed to provide the desired functionality using conventional programming/configuration techniques for equipment in wireless telecommunications systems. The transmitter 286 and the receiver 282 may comprise signal processing and radio frequency filters, amplifiers and circuitry in accordance with conventional arrangements. The transmitter 286, the receiver 282 and the controller 280 are schematically shown in FIG. 3 as separate elements for ease of representation. However, it will be appreciated that the functionality of these elements can be provided in various different ways, for example using one or more suitably programmed programmable computer(s), or one or more suitably configured application-specific integrated circuit(s)/circuitry/chip(s)/chipset(s). As will be appreciated the infrastructure equipment 272 will in general comprise various other elements associated with its operating functionality.

Correspondingly, the controller 290 of the UE 270 is configured to control the transmitter 296 and the receiver 292 and may comprise processor circuitry which may in turn comprise various sub-units/sub-circuits for providing functionality as explained further herein. These sub-units may be implemented as discrete hardware elements or as appropriately configured functions of the processor circuitry. Thus the controller 290 may comprise circuitry which is suitably configured/programmed to provide the desired functionality using conventional programming/configuration techniques for equipment in wireless telecommunications systems. Likewise, the transmitter 296 and the receiver 292 may comprise signal processing and radio frequency filters, amplifiers and circuitry in accordance with conventional arrangements. The transmitter 296, receiver 292 and controller 290 are schematically shown in FIG. 3 as separate elements for ease of representation. However, it will be appreciated that the functionality of these elements can be provided in various different ways, for example using one or more suitably programmed programmable computer(s), or one or more suitably configured application-specific integrated circuit(s)/circuitry/chip(s)/chipset(s). As will be appreciated the communications device 270 will in general comprise various other elements associated with its operating functionality, for example a power source, user interface, and so forth, but these are not shown in FIG. 3 in the interests of simplicity.

The controllers 280, 290 may be configured to carry out instructions which are stored on a computer readable medium, such as a non-volatile memory. The processing steps described herein may be carried out by, for example, a microprocessor in conjunction with a random access memory, operating according to instructions stored on a computer readable medium.

### Example Services

As mentioned above, there are a variety of services which may be supported by wireless communications networks. Development of physical layer, radio access and media access protocols and techniques can be adapted to support such services. Example services which are being defined for 5G/New Radio (NR) are the Ultra-Reliable and Low Latency Communications (URLLC) and the enhanced Mobile BroadBand (eMBB) services. URLLC has very low latency and high reliability where a URLLC data packet (e.g. 32 bytes) is required to be transmitted from the radio protocol layer ingress point to the radio protocol layer egress point of the radio interface within 1 ms with a reliability of 99.999% [5] to 99.9999%. On the other hand, eMBB requires high data rate of for example 20 Gbps with moderate latency and reliability (e.g. 99% to 99.9%).

Example developments for 3GPP are eURLLC [6] and NR Unlicensed (NR-U) [8]. For the example of eURLLC, proposals have been made to specify features for high reliability and low latency services such as factory automation, transport industry, electrical power distribution, etc. in a 5G system. Unlicensed radio frequency resources refer to a concept in which the radio resources are not exclusively allocated to a particular operator or radio communications system but are shared between systems, which to some extent compete for these resources. A 3GPP Release-16 NR-U work item specifies features for operation in unlicensed spectrum which includes incorporating Listen Before Talk (LBT) in the NR frame structure to enable NR operation in unlicensed bands.

Further developments of eURLLC have been proposed for 3GPP Release-17 in a work item [7] where one of the objectives is to incorporate characteristics associated with communicating via unlicensed radio resources, which thereby enable eURLLC operation in an unlicensed band.

### Channel Access in an Unlicensed Band

In the following paragraphs, an explanation is provided of current proposals for accessing communications resources from an unlicensed frequency band. In an unlicensed band, two or more systems may operate to communicate using the same communications resources. As a result, transmissions from different systems can interfere with each other especially when for example, each of the different systems are configured according to different technical standards, for example Wi-Fi and 5G. Additionally, two or more systems using the same technology can also interfere: for example two NR-U systems can interfere with each other. While NR-U systems provided by the same operator or managed by a common entity might in some cases be configured so as to reduce an amount of interference, systems using the same technology or standards and managed by another operator or entity are more likely to cause interference. As such, there is a regulatory requirement to use a Listen Before Talk (LBT) protocol for each transmitter operating in an unlicensed band to reduce interferences among different systems sharing that band. In LBT, a device that wishes to transmit a packet will firstly sense the band for any energy levels above a threshold to determine if any other device is transmitting, i.e. “listen”, and if there is no detected transmission, the device will then transmit its packet. Otherwise, if the device senses a transmission from another device it will back-off and try again at a later time.

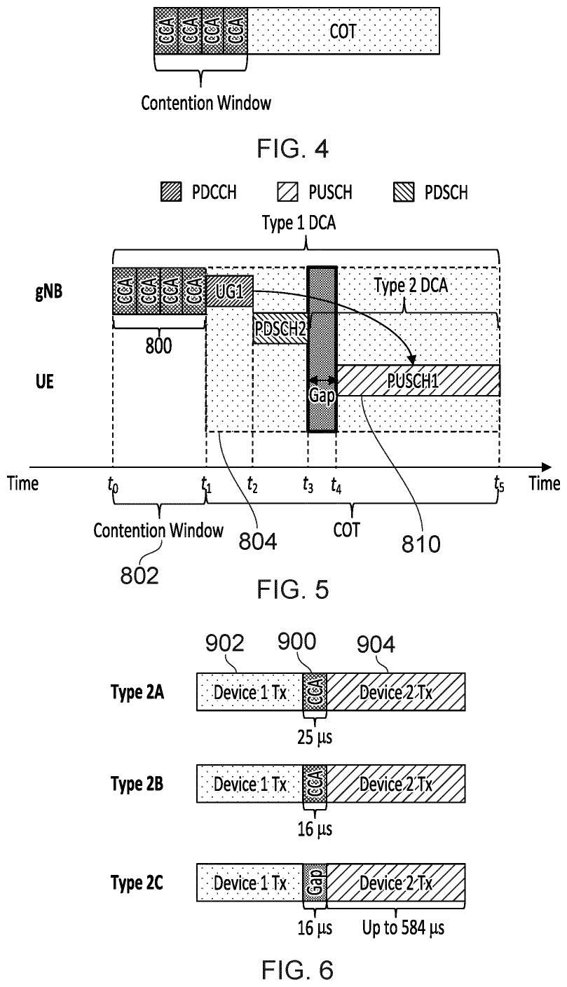

In NR-U, the channel access can be Dynamic (also known as Load Based Equipment) or Semi-Static (also known as Frame Based Equipment “FBE”), where both channel access schemes consist of one or more Clear Channel Assessment (CCA) processes in a Contention Window followed by a Channel Occupancy Time (COT) as shown FIG. 4. LBT is performed during the CCA phase by an NR-U device (e.g. gNB or UE) that wishes to perform a transmission. According to the CCA phase the NR-U device listens during one or more of the CCA attempts and if no other transmission is detected (i.e. energy level below a threshold) after the CCA phase, the NR-U device moves into the COT phase where it can transmit its packet in the COT resources. In Dynamic Channel Access (DCA) the CCA and COT phases can be different length between different systems whilst in Semi-static Channel Access, the CCA and COT phases have fixed time windows and are synchronized for all systems sharing the band.

In NR-U, a device can be an initiating device or a responding device. The initiating device acquires the COT by performing CCA and typically it initiates a first transmission, e.g. a gNB acquires the COT and transmits an uplink grant. The responding device receives the transmission from the initiating device and responds with a transmission to the initiating device, e.g. a UE receives an uplink grant and transmits the corresponding PUSCH. As will be appreciated, a UE can also be an initiating device, for example when it is transmitting a Configured Grant PUSCH and the gNB can be a responding device.

Some systems are configured with two types of Dynamic Channel Access (DCA), which are referred to as Type 1 and Type 2. In a Type 1 DCA, a Counter N is generated as a random number between 0 and CWₚ, where the Contention Window size CWₚ is set between CW_{min,p} and CW_{max,p}. The duration of the COT and the values {CW_{min,p}, CW_{max,p}} depend on the value p, which is the Channel Access Priority Class (CAPC) of the transmission, which may be determined for example by a QoS of the transmitting packet. A Type 1 DCA is performed by an initiating device and once the COT is acquired, one or more responding devices can use Type 2 DCA for their transmissions within the COT. Type 2 DCA may require a short CCA or no CCA prior to transmission if the gap between the transmission of two devices is less than 25 μs. If the gap is greater than 25 us then the responding device needs to perform Type 1 DCA.

FIG. 5 provides an illustration of frequency against time for transmission in an unlicensed band. As shown for the example of FIG. 5, an example of Type 1 DCA transmission and a Type 2 DCA is shown. According to the example shown in FIG. 5, at time to, the gNB wishes to send an uplink grant, UG1, to the UE to schedule PUSCH1. The gNB performs a Type 1 DCA starting with a Contention Window with four CCA's 800, so that for this example the random number is N=4, and detects no energy during this Contention Window 802, thereby acquiring the COT 804 between time t₁ to t₅. The gNB then transmits UG1 to the UE scheduling a PUSCH1 (810) at time t₄. The gNB may transmit PDSCH2 to the UE or another UE between time t₂ and t₃, although it will be appreciated that in some cases the base station may not transmit on a downlink shared channel or may transmit more than one transmission on the downlink shared channel.

The UE receiving the uplink grant UG1 then can use Type 2 DCA if the gap between PDSCH2 and the start of its PUSCH1 transmission, between time t₃ and t₄ is below a threshold, otherwise the UE will have to perform a Type 1 DCA. That is to say, if the granted PUSCH1 is less than a threshold time from the gNB's transmission, then the UE is not required to itself contend for the resources on the unlicensed band (by transmitting in the CCA and then COT according to the Type 1 DCA) and can use the resources of the COT acquired by the base station.

There are three types of Type 2 DCA as shown in FIG. 6, which are defined with respect to a length of the gap 900 between transmission 902 by a first device (initiating device) and a second device 904 (responding device) within a COT and therefore whether the second responding device needs to perform a CCA:
Type 2A: The gap between two transmissions is strictly more than 16 us and not more than 25 us and the UE performs a single Clear Channel Assessment (CCA) within this gap 900. In other words, in this example, the duration of the gap T_{gap} is 16 μs<T_{gap}≤25 μs
Type 2B: The gap between two transmissions is not more than 16 μs and the UE performs a single CCA within this gap 900 (in this example, the duration of the gap T_{gap} is T_{gap}≤16 μs)
Type 2C: The gap between two transmissions is not more than 16 μs and no CCA is required within this gap 900 (in this example, the duration of the gap T_{gap} is T_{gap}≤16 μs)

It will be appreciated that the configuration above relates to a current pre-agreed (standardised) configuration and that other configurations may be used. In general, for Type 2 access, the values for the gap duration boundaries 16 μs and 25 μs could take any other appropriate minimum and maximum and the configuration may also refer to the minimum or maximum value being included (e.g. “≤” and “≥”, respectively) or excluded (e.g. “<” and “>”). It should also be noted that fewer or more Access Types or Type configurations may be used while still being able to apply the teachings and techniques provided herein.

### Semi-Static Channel Access (SCA)

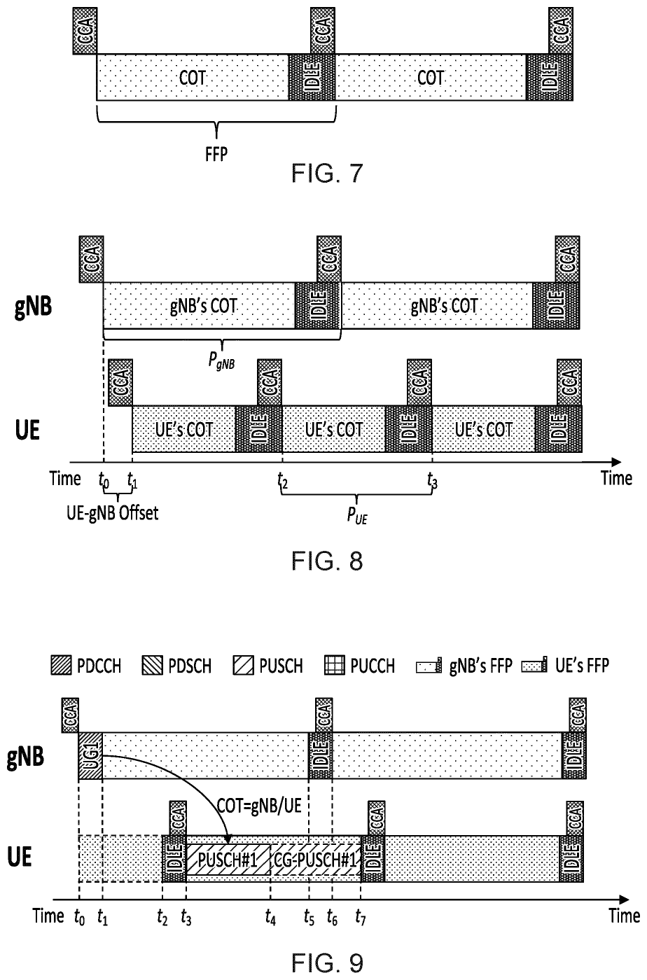

FIG. 7 provides an illustration of an example Fixed Frame Period “FFP”. In Semi-static Channel Access (SCA), also referred to sometimes as a Frame Base Equipment (FBE) mode, a Fixed Frame Period (FFP) is defined for COT initiation. In this example, the FFP comprises a COT portion (e.g. time period) and an Idle portion (e.g. time period) where the gNB or UE do not transmit any transmissions. An example of an FFP is illustrated in FIG. 7.

In the present disclosure, the frame “period” is understood to refer to the time between a first instance of a frame element and the subsequent instance of the frame element. For example, it can be measured by the time before the start or the end of a frame is repeated. In a structure as illustrated in FIG. 7, it may for example be measured by the time between the start of a COT and the end of the idle portion. In cases where a gap may be provided between the COT and/or idle portions of a first frame and the COT and/or idle portion of a second frame, the period may be measured by the time between the start of a frame and the start of the subsequent frame—or the end of the frame and the end of the subsequent frame.

In a contention-based access, for example as discussed above, one or more Clear Channel Assessment (CCA) process is carried out in the idle portion. In the example of FIG. 7, the CCA (or said differently the LBT) is performed before the COT can be used and is performed during the Idle portion of the frame. Mechanisms may be put in place to determine for how long the COT remains acquired by the base station (or other network node, such as a terminal, if appropriate) until it is released. In some examples, in cases where the COT is acquired after the CCA process(es), CCA is not required within the acquired COT as long as the gap between two transmissions is not more than a predetermined threshold, for example 16 μs. In cases where the network node does not use the COT for a time greater than the predetermined threshold (e.g. the network does not transmit for 16 μs or longer after its last transmission), the network will have to perform CCA again. The rationale for such mechanisms being that another network node might have successfully carried out its own CCA procedures while the first network node was not transmitting. In some systems, such as Release 16 NR-U systems, FFP is defined for the gNB and its parameters are configurable and broadcast in SIB1. These parameters can for example include an offset (e.g. relative to the start of radio frame SFN=0) and period (duration of one or more of the FFP, COT and Idle period), where the FFP parameters may be reconfigured every 200 ms. In other words, the gNB is expected to maintain the FFP configuration for at least 200 ms before it can be reconfigured (if appropriate). It will be appreciated that in most systems, the network is not expected to transmit during its Idle period. Instead, this period is used for listening (if the network node wishes to send a transmission) for LBT or CCA procedures.

It will also be appreciated that in some systems, the “Type 2” techniques discussed above can be applied in an SCA environment. For example, once a device has acquired a COT, another device can transmit within the COT, depending on conditions or parameters, for example as discussed above in respect of Type 2 access.

While in this example the frame is defined as comprising a COT portion and a subsequent idle or LBT period, and is followed by the subsequent frame without any gap in-between, it will be appreciated that in other examples the frame could be defined as comprising an idle portion and a subsequent COT portion; an idle portion and two COT portions positioned before and after the idle portion; two or more COT portions; two or more idle portions; a gap between a frame and the subsequent frame (wherein a gap is not used for transmitting data or for performing a LBT process) or any technically conceivable combination thereof. The teachings and techniques provided herein apply equally to these different arrangements.

In some systems, such as in Release 16 for NR-U systems, the gNB indicates (e.g. via signalling such as the DCI) to the UE when the UE can use the gNB-initiated COT or configures the UE (e.g. via signalling, such as RRC signalling) with the time at which it can use the gNB-initiated COT. From that perspective, as the COT is configured and/or activated by the gNB, this is referred to as a “gNB-initiated” COT. In this example implementation, the FFP parameters comprise an offset parameter and period which are configurable and broadcasted by the gNB in system information SIB1. The offset parameter configures an offset relative to the start of the radio frame with System Frame Number (SFN) zero and is illustrated in FIG. 8, as discussed below. The period parameter configures the duration of the FFP. In current systems, the FFP parameters can be reconfigured every 200 ms. In other words, the same FFP configuration is maintained by the gNB and the UE for at least 200 ms before it can be reconfigured (if appropriate).

It is expected that the Semi-static Channel Access (SCA) techniques are and will mostly be used in a controlled environment where the deployed unlicensed network is expected to experience limited interference from other unlicensed systems or devices. For example, an unlicensed network may be deployed using SCA in a factory where the use of other unlicensed systems such as Wi-Fi is not allowed. In such an environment, the FFP of each gNB in the network can be aligned and synchronized and the radio conditions can be optimised with limited considerations being given to possible interferences from third party systems or devices.

In some systems, such as Release 16 systems, only a base station can initiate a COT. However, in other systems, such as in Release 17 systems, a UE may also initiate a COT. This is expected to reduce latency in some communications thus to enhance the URLLC performance of mobile networks in an unlicensed environment.

Accordingly in some systems, a UE-initiated COT may be used in a Semi-static Channel Access (SCA) mode. The UE (or terminal) may also have a different FFP offset to that of the gNB. This is illustrated in FIG. 8 which shows an FFP configuration for a UE being different from an FFP configuration for the gNB. In other words, FFP of the UE and the FFP of the gNB are not aligned due to different FFP offset configurations. Other FFP parameters may also differ between a gNB COT and a UE COT. For example, different FFP period parameters may be used, which is also illustrated in FIG. 8. In other words, a gNB and a UE served by the gNB can have different FFP configurations. In some cases, the FFP configuration for the terminal's FFP may be configured by the base station and/or the network, for example using RRC signalling.

As previously mentioned, FIG. 8 illustrated an example of a terminal having a different FFP configuration from the base station, having a different offset and period to the gNB's FFP. It will also be appreciated that the terminal's FFP configuration may alternatively or additionally differ from the FFP configuration for another UE's FFP configuration. In the example of FIG. 8, there is an offset between the start of the gNB's FFP and the UE's FFP (between t₀ and t₁). Also in this example, the gNB FFP period is P_{gNB} and the UE FFP period is configured to be P_{UE} where P_{gNB} is different to P_{UE}. In this case P_{gNB}>P_{UE}, which is expected to correspond to the main use case, but it will be appreciated that in other cases, the configuration may be with P_{gNB}<P_{UE}.

In some systems, once a COT has been acquired by a device (e.g. by a terminal or base station), the so-called “COT initiator”, a device responding to the COT initiator (so-called “responding device”) is not allowed to transmit in the idle period of the COT initiator. For example, if the gNB is the COT initiator, the UE is not allowed to transmit during the gNB's Idle period. Likewise, if the UE is the COT initiator, then the base station (e.g. gNB) is not allowed to transmit during the UE's Idle period.

It will however be appreciated that, if the UE has acquired the COT, the UE may transmit during an Idle period of the gNB's COT, if for example an Idle period of the gNB's FFP aligned with one of its COT periods and the UE has not released the COT. Likewise, if the gNB has acquired the COT, it may transmit in a time period which corresponds to a UE's Idle period, if for example the base station has not released its COT and if the UE's Idle period overlaps with the gNB's COT period.

Said differently, whether a UE can transmit during a gNB's FFP idle period or its own FFP idle period can depend on who the COT initiator is. Accordingly, for an uplink transmission in the UE's COT period, it is helpful for the UE to know whether the uplink transmission follows the UE's COT or the gNB's COT. For example, the uplink transmission might be scheduled at the start of the UE's COT and may thus be a candidate for being sent using the UE's COT or the gNB's COT. For example, the UE may be able to initiate its own COT just prior to that transmission, in which case the transmission will be under the UE's COT, or it may be done using the gNB's COT. Whether the COT initiator at the time of this transmission is the UE or the gNB will therefore determine whether the UE can transmit during the FFP idle period of the gNB or UE.

For a scheduled uplink transmission (e.g. a PUSCH scheduled by an UL Grant or a PUCCH scheduled by a DL Grant), the gNB may in some cases indicate in the Downlink Control Information (DCI) scheduling the transmission whether that uplink transmission follows the UE's COT or the gNB's COT. The gNB may then indicate who the COT Initiator is for an uplink transmission. Whether the COT Initiator is the gNB or UE would also determine whether the UE will perform LBT to try to acquire a COT prior to the UL transmission, or if it is the gNB's COT, in which case the UE does not need to perform LBT to acquire a COT.

An example is shown in FIG. 9, where the gNB initiated a COT at time to and transmits an UL Grant (UG1) to the UE to schedule PUSCH #1 to start at the UE's FFP frame boundary at time t₃. In this example, the gNB also indicates in UG1 whether PUSCH #1 is transmitted according to the gNB's COT or the UE's COT. This can be used by the UE to determine whether the UE's uplink transmissions (e.g. including any possible subsequent transmissions) will end at time t₅ (prior to gNB's FFP idle period) or may continue until time t₇ (prior to UE's FFP idle period). For example, if the UE is configured with a Configured Grant “CG” PUSCH, it can continue to transmit CG-PUSCH #1 from time t₄ to t₇ if PUSCH #1 was transmitted according to the UE's COT., Otherwise if PUSCH #1 is transmitted according to the gNB's COT, the UE will stop at time t₄ after transmitting PUSCH #1, or could transmit a transmission (e.g. “CG” PUSCH) between time t₄ and t₅.

In other words, using the indication in the grant (uplink grant for a PUSCH transmission or downlink grant for a PUCCH transmission associated with a PDSCH transmission), the terminal can determine whether the transmission will be based on the timings or COT of the base station or of the terminal. The terminal can thus make transmission decisions based on this indication, such as determining whether to transmit at a point in time based on this indication, wherein if the point in time falls within the Idle period of the frame structure identified in the indicator (whether this is the UE or gNB) and currently used by the terminal, the terminal will not transmit at this point in time.

Some of the differences in behaviour in current systems, between the UE transmitting according to the gNB's COT and the UE transmitting according to its own COT are identified in the table 1 below:

TABLE 1

| Function | gNB's COT | UE's COT |
|---|---|---|
| LBT | UE does not need to perform | UE does not need to perform |
| | LBT before UL transmissions | LBT before UL transmissions |
| | when the gap between two | when the gap between two |
| | transmissions is not more than | consecutive UL transmissions |
| | a threshold, e.g. 16 μs | is not more than a threshold, |
| | For example if the gap | e.g. 16 μs. |
| | between the last DL | UE performs LBT before UL |
| | transmission and the UL | transmissions when the UL |
| | transmission is less | transmission starts at UE's |
| | than the agreed threshold. | FFP boundary or when the |
| | UE must perform LBT before | gap between two consecutive |
| | UL transmissions when gap | UL transmissions is more |
| | between two transmission is | than the threshold, |
| | more than the threshold, | e.g. 16 μs. |
| | e.g. 16 μs. | |
| Length | UE's UL transmission | UE's UL transmission can |
| of UL | cannot extend into the | extend into IDLE period of |
| trans- | IDLE period of gNB's | gNB's FFP, as long as it |
| mission | FFP | isn't within the IDLE |
| | | period of the UE's FFP. * |
| Subse- | UE's subsequent UL | UE's subsequent UL |
| quent UL | transmissions cannot extend | transmissions can extend |
| trans- | into the IDLE period of | into the IDLE period of |
| missions | gNB's FFP | gNB's FFP. |

* Note:
it is also conceivable that the gNB might indicate to the UE to transmit according to the UE's COT with the express intention of allowing such a “long” uplink transmission extending after the scheduled uplink transmission and/or within the gNB IDLE period.

### Grant and Transmission in Different Frames

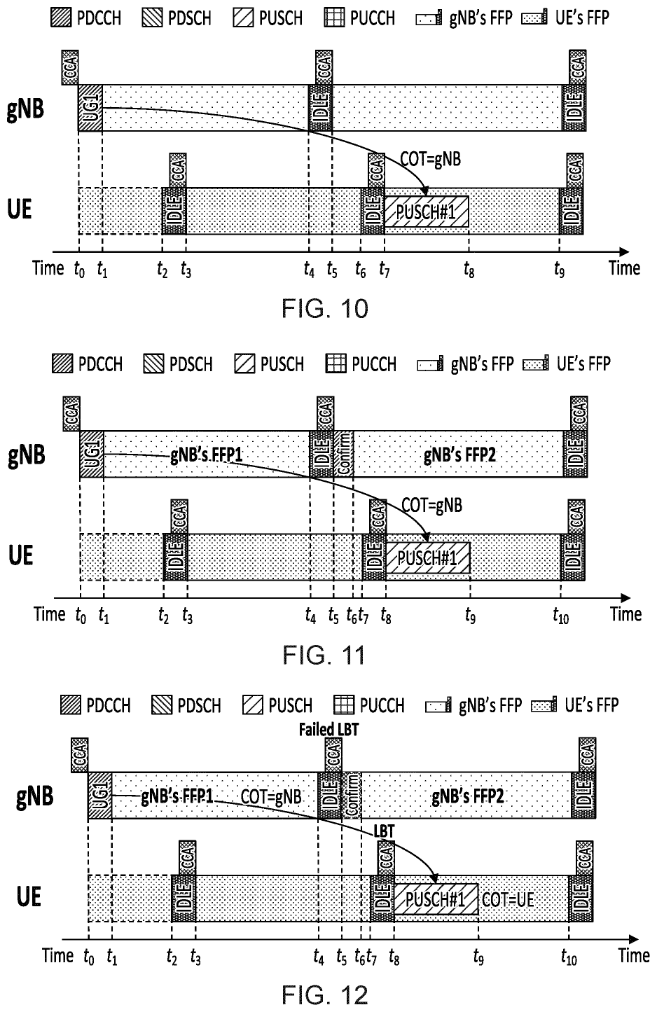

In some systems, the gNB can also schedule an uplink transmission for a UE in a gNB's future FFP to maintain the gNB's scheduling flexibility. This is illustrated in FIG. 10 where the gNB acquires a COT at time to and sends an UL Grant (UG1) to the UE to schedule PUSCH #1 at time t₇, which is in the gNB's next FFP. In this and other examples, the scheduled uplink transmission is at the start of the UE's FFP boundary but the same principles can apply if the transmission is in another part of the UE's COT or FFP. In this case, the gNB is expected to acquire the second COT by using an LBT procedure between t₄ and t₅. As previously mentioned, this type of channel access is expected to be used in more controlled environments where the level of interferences caused by other systems is expected to be relatively low.

However, it will be appreciated that for cases where the gNB indicates that the UE's transmission follows the gNB's COT for a scheduled uplink transmission in a gNB's future FFP, there is a risk that the gNB fails to acquire a COT in that FFP. Even in a controlled environment where the gNB is likely to acquire the COT in most cases, there is still no guarantee that the gNB will pass the LBT process, due to the operations being in an unlicensed spectrum and therefore a less controlled spectrum.

In such a case, where the gNB schedules the uplink transmission in a future COT and is unable to acquire that COT, there is a risk of conflict between transmissions and it is challenging for the UE to determine what might be considered an optimal or satisfactory behaviour.

For example and returning to the example of FIG. 10, The gNB has indicated that PUSCH #1 will be transmitted according to the gNB's COT (said differently, that the gNB will be the COT initiator for that COT) but if the gNB fails to acquire that COT at time t₅, this creates uncertainty. It would therefore be desirable to provide techniques which enable the network nodes (e.g. base stations and terminals, amongst others) to better handle the uncertainty and to identify a satisfactory behaviour in this ambiguous situation.

In accordance with techniques of the present disclosure, the base station (or more generally, the network that sent a grant for a transmission in one of its future COT) can transmit an indicator, for example a COT Confirmation indicator, at the start of a COT of the FFP where the transmission has been scheduled. The indicator can be used to confirm whether the network node (e.g. base station) has been able to acquire the COT or not. The other network node (e.g. UE) can monitor the transmissions from the first network node for the COT Confirmation Indicator, wherein in some cases the other network node is configured via RRC signalling to monitor the indicator.

Looking at the receiving device (which we will assume to be a UE in the illustrative examples, but the present disclosure is not limited to this example), the UE that has been scheduled an UL transmission at a later gNB's FFP (e.g. at the start of UE's FFP, as this might be desirable in some cases) and where the corresponding message (e.g. DCI) carrying that grant was scheduled in a previous gNB's FFP, will monitor whether the indicator is transmitted or not transmitted by the first device (which we will assume to be a base station or gNB in the illustrative examples, but the present disclosure is not limited to this example). It will also be appreciated that in this or other examples of the present disclosure, the grant message may comprise a grant which can be a UL Grant for an uplink user data transmission like PUSCH, DL Grant for an uplink control data transmission like PUCCH, a Grant for aperiodic Sounding Reference Signal (SRS) transmission (which may be e.g. for estimating channel state between the gNB and the UE, or for measuring UL beam quality), an activation DCI for CG-PUSCH or any other suitable type of grant which schedules a transmission from the first device to the receiving device in a later FFP or COT.

Accordingly, the UE can monitor for the COT Confirmation Indicator to determine whether the COT initiator is the gNB or not, which will in turn affect whether the UE will configure its transmissions according to the gNB's COT or UE's COT and for example whether the UE can transmit during the base station's idle period of the base station's FFP.

### UE Modes of Operation

As mentioned above, the UE may be configured according to one or more different behaviours or modes of operation when such a COT confirmation indication is used.

### Indicator Monitoring not Configured or not Activated

In an example, if the UE is configured not to use the monitoring mode or is not configured to use the monitoring mode for monitoring for a COT Confirmation indicator (that is, the monitoring is not active, for example because it has not been activated), the UE may assume an uplink transmission is under a UE-initiated COT if the uplink transmission and the DCI that schedules the transmissions are in different FFPs of the gNB. This can be the case, even if (or regardless of whether) the grant message indicates that the gNB is the COT initiator or not.

In this example, the UE will always assume that it is the COT initiator for its transmission, regardless of what was indicated in the grant message (for example that the gNB intended to be the COT initiator). On one hand, this will remove the ambiguity for the UE as the UE will always assume that it is the UE that is the COT initiator and will therefore be able to identify the frame structure and timing to use for its transmissions. On the other hand, it will be appreciated that this may sometimes delay the next COT that the base station may acquire. For example if the UE starts transmitting within the IDLE period of the gNB's FFP, the gNB may fail to acquire a COT as a result.

### Indicator Monitoring Active—Transmission Requested Using Base Station's COT

If the COT Confirmation Indicator mode is configured for a UE (by default or dynamically), the UE can monitor for a COT Confirmation Indicator if it has been scheduled a transmission (e.g. uplink transmission) where the uplink transmission and the corresponding DCI scheduling the transmission are in different FFPs of the gNB. As will be discussed below, in some cases and even if a COT confirmation is transmitted by the base station, the UE may ignore the COT Confirmation Indicator (which would provide a small battery power saving) and transmit the uplink transmission according to its own FFP configuration, using its COT.

In these examples, the UE is configured to monitor for an indicator such as a COT Confirmation Indicator. For example, the UE may be operating with an active indicator monitoring mode. The gNB sends a grant message (e.g. DCI) in a gNB's first FFP which schedules an uplink transmission within a gNB's second FFP, where the gNB's first FFP “FFP1” is different to the gNB's second FFP “FFP2” (which may be a future FFP which may or may not be adjacent to FFP1, as discussed below). In these examples, the uplink transmission is shown to start at the UE's FFP boundary, as the present techniques are more likely to be used in such cases, but the teachings and techniques provided herein are not limited to this and apply equally to other configurations, as discussed below.

FIG. 11 illustrates the transmission of this indicator and an example of a UE's corresponding behaviour in response to detecting the indicator. This case is similar to that discussed in respect of FIG. 10: the gNB acquires a COT at time to and transmits an UL Grant UG1 in a gNB's FFP1 (e.g. in the COT portion of FFP1), to schedule PUSCH #1 for the UE in another of the gNB's FFPs, FFP2. In this case, PUSCH #1 is scheduled at the start of the UE's FFP boundary at time t₈, which is also in another FFP of the gNB's, i.e. in a different FFP from FFP1 in which the COT was transmitted. It will be appreciated that even though in this example the two FFP are consecutive or adjacent ones, the same teachings apply to other situations, as discussed below.

In this example, the gNB also indicates that the UE transmits PUSCH #1 according to the gNB's COT, namely that the gNB indicates that the FFP configuration to use is that of the gNB (or, using the terminology used above, that the base station is the COT initiator). At time t₅, the gNB acquires the COT where the transmission has been scheduled and transmits a COT Confirmation indication at the start of that COT. The UE can then detect the COT Confirmation Indicator and become aware that the gNB had acquired the COT. Accordingly, the UE can transmit PUSCH #1 according to the gNB's COT (as indicated by UG1).

In another example, the UE fails to detect a COT Confirmation indicator, which can for example be the result of the gNB being unable to acquire the COT (as illustrated in FIG. 12) or to the UE not successfully receiving a confirmation indicator transmitted by the gNB. When the UE fails to receive the confirmation, the UE can initiate a COT and try to acquire a COT and transmit the UL transmission under the UE's COT. If the UE manages to acquire a COT by successfully carrying out a LBT procedure, it will transmit the scheduled transmission, but using its own COT and therefore its own FFP configuration. For example, it may transmit at a time which is an IDLE time for the gNB FFP (and which is not an IDLE time for the UE's FFP).

FIG. 12 illustrates a situation in accordance with this example mode of operation. In this example, the gNB indicates in the DCI that a scheduled UL transmission is transmitted under the gNB's COT in a future gNB's frame, FFP2. As illustrated in this example, the gNB acquires a COT at time to and sends an UL Grant UG1 in FFP1 (a gNB's FFP) to schedule PUSCH #1 in FFP2 (a gNB's FFP). The gNB also indicates in the DCI in FFP1 that the gNB is the COT Initiator for the scheduled UL transmission in FFP2. The gNB fails the LBT procedure to acquire FFP2 and therefore does not transmit a COT Confirmation Indicator at the start of FFP2. As the UE is unable to detect the COT Confirmation Indicator, in this mode of operation, the UE will perform LBT to acquire a COT at time t₈ and transmits PUSCH #1 according to the UE's COT.

In a further example, if the gNB indicates in the grant message, e.g. in a DCI, in FFP1 that the gNB is the COT Initiator for the scheduled UL transmission within the gNB's 2^{nd} FFP and the UE fails to detect a COT Confirmation indicator, the UE can cancel the scheduled UL transmission. This example appreciates that in some cases, the indicator was transmitted but the UE was not able to successfully receive the indicator transmitted by the gNB. This example may be beneficial in cases where this can for example be caused by poor radio conditions. In this example, the UE may cancel the transmission out of caution.

It will be appreciated that, more generally, which approach or mode to use may be configured in the terminal, by the network and/or might change dynamically. For example, the terminal might be preconfigured to be able to determine which mode to use (which might be a single mode or one or more modes with a selection process), may be configured by the other network node to use one or another mode (e.g. based on what the base station expects might be optimal) and/or might receive mode selection parameters from the other network node (e.g. a noise detection threshold and/or network quality metrics to be used to determine whether to use, if the indication is not detected, the mode where the transmission is cancelled or the mode where the terminal will try to acquire its own COT).

Returning to this example mode of operation, whether to use this mode and cancel the scheduled transmission could be based on whether the terminal has received some energy or not at a time when the indicator was expected, which can provide an indication of whether the gNB might have sent the indicator but the UE was unable to decode the signal. For example, with a view to avoiding having the UE transmitting the UL transmission (or other transmissions) using the UE's FFP configuration (e.g. assuming that the UE is a valid COT initiator), which may lead to interfering with other transmissions and/or with an FFP idle period of the base station, the UE can cancel the transmission.

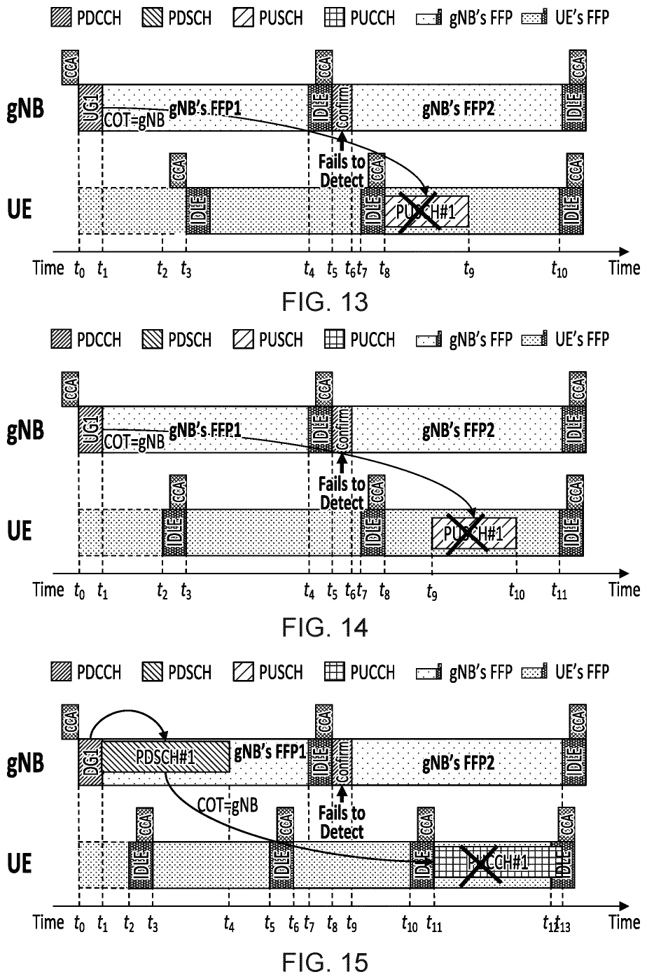

FIG. 13 illustrates an example operation in accordance with this example mode. The gNB transmits an UL Grant in FFP1 to schedule PUSCH #1 in FFP2 and indicates that PUSCH #1 is transmitted under the gNB's COT. During the idle period of the base station's FFP, the base station performs a listen-before talk procedure (or any other suitable contention-based access procedure) and upon successfully completing the procedure, the base station transmits a confirmation indicator at time t₅ to notify the UE that it has successfully acquired the channel. However, at the start of FFP2, the UE monitors but fails to detect the COT Confirmation Indicator which the gNB transmitted. In this case, the terminal will cancel the transmission of PUSCH #1.

As discussed above, this behaviour may be based on the terminal detecting noise at the time when the indicator was expected, e.g. noise above a threshold, such that the terminal will cancel the transmission. On the other hand, if a significant enough amount of noise is not detected (for example in the case of FIG. 12 where the indicator was not transmitted), the terminal may attempt to acquire the channel and transmit the scheduled transmission using its own FFP configuration and COT. In other cases, the terminal may be configured to always cancel the transmission if the indicator has not been detected and to only transmit the scheduled transmission in cases where the indicator was successfully received.

As discussed above, in some examples in accordance with the present disclosure and where a COT Confirmation Indicator is used, the scheduled UL transmission (scheduled by the grant message—e.g. DCI—in the first gNB's FFP and within the gNB's FFP2) may not start at the boundary of the UE's FFP. For example, it may not be scheduled at the start of the FFP and may instead be located in the middle of a COT period of a UE's FFP.

In some cases, if the gNB indicates in the grant message in FFP1 that the gNB is the COT Initiator for the scheduled UL transmission in FFP2 and the UE fails to detect a COT Confirmation indicator, the UE may transmit the uplink transmission according to the UE's COT or cancel the uplink transmission depending on whether the uplink transmission starts at the UE's FFP boundary or not.

It will be appreciated that in some current systems the UE may be configured to attempt to acquire its own COT only when both the following two requirements are met:
1. CCA at UE's FFP boundary succeeds, that is the terminal was able to succeed in its contention-based access procedure performed in the idle period before the COT period
2. A signal is transmitted immediately after the successful CCA. Namely, such terminals are not allowed to wait after the successful contention-based access procedure and are expected to transmit straight after the procedure.

Accordingly, to accommodate systems that implement configurations like this, the terminal may be configured to operate implementing one or more of the following configurations:
a. If the scheduled transmission starts at the UE's FFP boundary, the UE can transmit the UL transmission assuming it is under its FFP configuration, e.g. using its COT. For example, it may do so if the indicator was not detected.
b. if the UL transmission does not start at the UE's FFP boundary, the UE cancels the scheduled transmission.
c. if the UL transmission does not start at UE's FFP boundary and is adjacent to another transmission or to a group of two or more adjacent further transmissions, when the other transmission or group of two or more adjacent further transmissions start at the UE's FFP boundary, the UE can transmit the UL transmission assuming it is under its COT. When the other transmission or group of two or more adjacent further transmissions do not start at UE's FFP boundary, the UE cancels the scheduled transmission.

An example of how condition b. above may be used is illustrated in FIG. 14. This figure corresponds to FIG. 12, where the UE has not received the indicator (the UE being unaware of the reason for this) and where the UE is considering whether to transmit the scheduled transmission. In the case of FIG. 14, the UE is configured to determine whether to send the scheduled transmission based on whether it is aligned with the start of the transmission portion (COT) of the FFP starting at t₈ or not, and since the scheduled transmission starts at t₉, the UE will cancel the transmission.

In another embodiment, if the gNB indicates in the grant message (e.g. DCI) in FFP1 that the gNB is the COT Initiator for the scheduled UL transmission in FFP2 and if the UE fails to detect a COT Confirmation indicator at the start of FFP2, the UE may determine whether to transmit the uplink transmission according to the UE's COT (or for example cancel the uplink transmission) depending on whether the scheduled transmission overlaps with an FFP Idle Period of the UE's FFP configuration and/or of the gNB's FFP configuration.

For example, in a case where the UE has determined or selected the UE's FFP configuration to transmit the scheduled communication:
a. if the scheduled transmission does not overlap with the UE's FFP Idle Period, the UE can transmit the UL transmission using the UE's COT;
b. if the scheduled transmission overlaps with the UE's FFP Idle Period, the UE can drop or cancel the transmission.

An example is shown in FIG. 15, where at time t₁, the gNB acquires a COT in FFP1 (between t₁ to t₈ for an FFP structure starting with the transmission or COT portion, followed by a quiet or idle period) and sends a DL Grant DG1 to the UE to schedule PDSCH #1. The HARQ-ACK for PDSCH #1 is scheduled in PUCCH #1, which starts at the start of a UE's FFP at time t₁₁ and in the gNB's FFP2. The gNB indicates in DG1 that PUCCH #1 is transmitted according to the gNB's COT.

According to the present disclosure, the UE tries to detect a COT Confirmation Indicator at the start of the FFP2. However, in this example situation, the UE fails to detect it. As mentioned above, the UE doesn't know whether the gNB has acquired the COT in FFP2 or not. In this example, the UE determines that it cannot use its COT because PUCCH #1 overlaps with its own FFP idle period between time t₁₂ and t₁₃. Therefore, according to this example, the UE cancels the transmission of PUCCH #1.

This mode of operation enables the UE to transmit over its own FFP idle period only if it is transmitting under the gNB's COT. As the skilled person will appreciate, if the UE fails to detect a COT Confirmation Indicator, this could mean the gNB failed to acquire the COT or that the gNB acquired the COT but that the UE missed the indicator, and if the scheduled transmission overlaps the UE's FFP idle period, then it may be preferable for the UE to cancel the transmission.

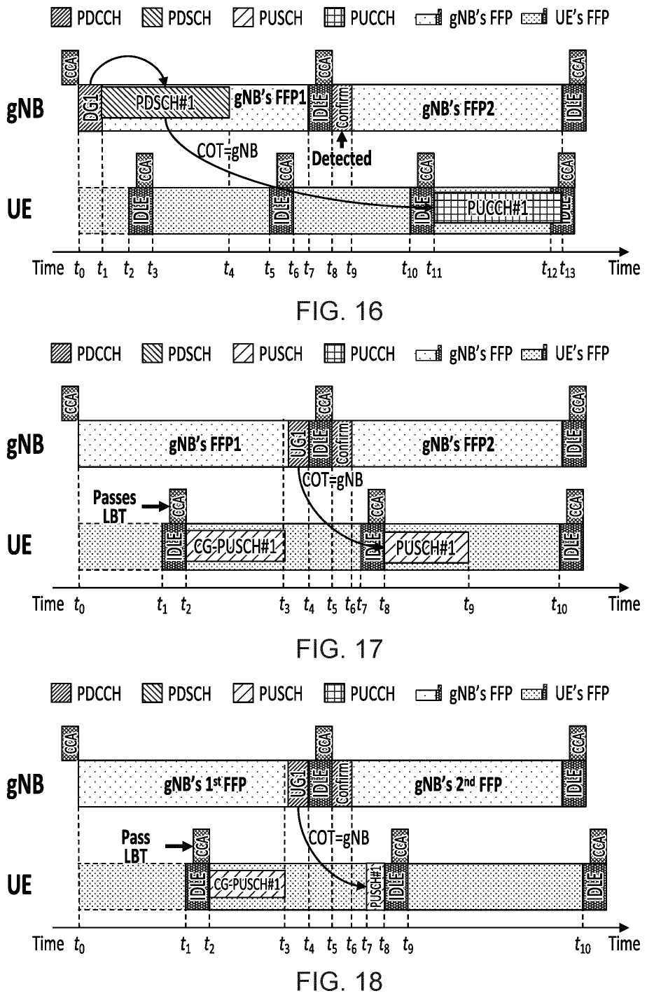

It will be appreciated that in a similar but different case, the UE may transmit over its own idle period. For example, FIG. 16 corresponds to FIG. 15 but where the terminal detects the Indicator transmitted at the start of FFP2. In this case, the terminal can transmit the scheduled transmission as it does not overlap with the IDLE of the FFP configuration currently in use, namely with the IDLE period for the gNB FFP. Although this is not illustrated in FIG. 16, in systems where transmissions according to a COT have gaps of less than a predetermined threshold between them (e.g. 16 μs or 25 μs), such transmissions in accordance with the gNB's COT would be expected between t₀ and t₁₁. It will also be appreciated that, from the UE's perspective, as long as the indicator is received and confirms that the gNB has acquired the COT in FFP2, the UE does not have to determine whether this condition is met and it can transmit in the allocated resources.

It will also be appreciated that the terminal may also determine whether the scheduled transmission overlaps with the gNB's Idle period before determining whether to transmit on the UE's or gNB's COT. However, in most cases, this is expected to be less selective as the gNB would not normally be expected to schedule a transmission overlapping its idle period when indicating that the UE should use its COT.

While some of the examples discussed herein discuss how a terminal can determine whether to cancel or transmit the scheduled transmission when the confirmation has not been received, it will be appreciated that it can make this determination based on configuration received via signalling, for example control signalling. In an example, the gNB indicates in the DCI in FFP1 that the gNB is the COT Initiator for the scheduled UL transmission in FFP2 and the UE fails to detect a COT Confirmation indicator. Then, whether the UE should transmit or cancel the scheduled transmission can be signalled by the network, for example the base station may configure the UE to behave according to one of two or more modes. The UE can be further notified (e.g. using control signalling) whether, if the scheduled transmission is to be transmitted, it should be transmitted according to the gNB's COT or the UE's COT. The signalling to configure these aspects can be for example an RRC configuration or dynamically indicated, for example in a grant message, such as the grant message that schedules the scheduled transmission being considered.

While many of the examples herein are presented with the gNB acquiring a COT in a gNB's first FFP and scheduling an UL transmission in a gNB's second FFP, the same teachings apply equally when the UE (or another network node) acquires a COT of one of its FFPs first and the base station (or another network node) schedules resources using a grant sent using the UE's COT.

In other words, these examples and their associated teachings are also applicable for cases where the gNB acts as a responding device, after the UE has acquired the COT. For example, the gNB schedules a UE in a first gNB's FFP to transmit in a gNB's second (or more generally later) FFP, where the UE had previously acquired a COT within the gNB's first FFP.

An example is illustrated in FIG. 17, where the UE acquires a COT at time t₂ after successfully performing an LBT procedure. The UE then transmits CG-PUSCH #1 using its own COT. Then, in the same UE's COT and also in the gNB's first FFP “FFP1” and as a responding device, the gNB transmits UL Grant UG1 after receiving CG-PUSCH #1 at time t₃ to schedule the UE with PUSCH #1 in the gNB's 2^{nd} FFP. As mentioned above, even if the current COT was acquired by the UE, the gNB may be allowed to transmit, for example if the gap between the end of the UE transmission (at t₃ in FIG. 17) and the start of the base station transmission includes a gap of less than a predetermined threshold (e.g. 16 μs for a Type 2 access)

In this example the gNB indicates that PUSCH #1 is to be transmitted according to the gNB's COT, where the COT starts after the UE's COT (and in this case, where the gNB's COT in which PUSCH #1 is scheduled starts after the UE's COT starts and where the gNB's COT also overlaps with the UE's COT). The UE then monitors for a COT Confirmation Indicator at the start of gNB's second FFP and transmits PUSCH #1.

As mentioned before, if the UE transmits using the gNB's COT, it can transmit in a time period which overlaps with its own COT. Therefore, in this example, and in all other examples, the scheduled transmission can in some cases overlap with the UE's idle period. In the illustrative example of FIG. 17, the PUSCH #1 transmission can for example be scheduled to start at t₆ or t₇, or another time which causes the transmission to overlap with the UE's idle period.

It should be noted that, as the gNB schedules the transmission requesting it to be according to its own COT, in a future FFP where the COT cannot have been acquired yet, how this future FFP or COT aligns with the FFPs or COTs of the terminal is secondary and in most cases has no impact on the operations in accordance with the disclosure.

For example, when the gNB sends a grant message in a gNB's first FFP, the grant message scheduling an UL transmission in a gNB's second FFP, both the DCI scheduling the UL transmission and the UL transmission itself may fall in a single one of the UE's FFPs. An example of this scenario is illustrated in FIG. 18. The UE acquires a COT at time t₂ and transmits CG-PUSCH #1. After (or at) time t₃, the gNB sends an UL Grant UG1 which falls within FFP1 of the gNB and which is sent to the UE to schedule PUSCH #1 in FFP2 of the gNB. Here UG1 and PUSCH #1 are both within the same UE's FFP, however the same challenges can occur in this situation, as the grant is sent in a time which is before the gNB's FFP in which the scheduled transmission is scheduled such that the terminal may not know if the gNB will actually be able to acquire the COT.

### Indicator Monitoring Active—Transmission Requested Using Terminal's COT

In this example, the UE is configured and/or activated to monitor for an indication, such as a COT Confirmation Indicator, and the gNB sends a grant message (e.g. DCI) in a first of the gNB's FFPs. In this example the gNB indicates in the grant message that the scheduled UL transmission is to be transmitted under the UE's COT. For example, the uplink transmission is often expected to be scheduled to start at the UE's FFP boundary, in particular in the case where this is the only scheduled transmission for the terminal.

In this illustrative example, the grant message also schedules the transmission to start within a second and different FFP of the gNB's FFPs. As the base station has indicated to use the terminal's COT as per its FFP configuration, the UE will transmit the UL transmission according to the UE's COT regardless of whether the UE detects a COT Confirmation Indicator or not. That is, the UE does not have to monitor and/or can ignore the indication's transmission (and it will also be appreciated that the gNB may not transmit it as it is unlikely to be monitored by the terminal).

### Transmission of the Indication

### Explicit Indication

In some examples, the indication, for example COT Confirmation Indicator, is explicitly transmitted to the other network node, for example transmitted by the base station to a terminal. This can for example be transmitted as part of control signalling.

It may for example be transmitted in a grant message. For example, it may be transmitted in:
an individual grant message such as a DCI, which may be sent to the terminal,
a group grant message, such as a Group Common DCI (GC-DCI) which may be sent to a group of devices, including the terminal.

It will be appreciated that the base station (or more generally first network node) may opt to use one of several different types of messages depending on the circumstances, such as the number of devices which have been scheduled in a future FFP and are expected to monitor the indication and/or whether these devices are in a group. For example and if using DCI indications, in cases where the terminal (or more generally first network node) is the only terminal that might monitor the indication, the base station might decide to use a DCI sent to the terminal. On the other hand, if the terminal is part of a group of a plurality of terminals which includes at least two terminals expected to monitor the indication, the base station may determine to send the indication in a group DCI (even if some members of the group may not be expected to actively monitor the transmission).

In some examples, a new DCI field may be used to carry the indication or COT Confirmation Indicator in a DCI or GC-DCI. This new field may for example be a 1-bit indicator.

In some examples, the GC-DCI carrying the indication may re-use an existing format, for example use a DCI Format 2_0. DCI Format 2_0 carries a Slot-Format-Indicator “SFI” and can also be configured to carry a frame duration indicator named “co-DurationsPerCellToAddModList”. This frame duration indicator indicates the duration of a COT under a Dynamic Channel Allocation (DCA) or Load Based Equipment (LBE) mode of operation. As this field is not usually used when in an SCA mode of operation, it may re-used to carry the indicator without having to modify existing field or without creating new fields. Accordingly, for SCA operations, this COT duration indicator (e.g. “co-DurationsPerCellToAddModList”) may be re-used for providing the indication, such as a COT Confirmation Indicator.

It will also be appreciated that, even though a DCI provides a good candidate to signal the indicator, other types of downlink control signalling may be used as well or instead.

### Implicit Indication

In another example, the indication (e.g. COT Confirmation Indicator) can be implicitly indicated.

The implicit indication can be provided at the start of the gNB's FFP for the scheduled transmission, which is helpful for the terminal to determine which time or period of time to monitor.

The implicit indication may for example be one of:
A group downlink control information message such as a GC-DCI, which is monitored by the UE having the scheduled UL transmission. For example the group DCI message might be an allocation message, an Uplink Cancellation Indicator, a Transmit Power Control (TPC) command, etc. and does not necessarily have to be a message allocating resources or a message that will cause the UE to take action.
A grant message, e.g. DCI, for the UE with a scheduled UL transmission in the gNB's FFP, which can for example grant resources for a further transmission (uplink or downlink), in this FFP or yet another FFP (of the gNB or of the UE).
A broadcast message such as system information. An example of system information transmissions which may be used to indicate that the base station has acquired the COT include System Information Block (SIB).
A downlink reference signal such as one or more of: a Synchronisation Signal (SS) and a Reference Signal (RS). For example the network node may transmit a (SS)/PBCH block, periodic or semi-persistent CSI-RS, or PDCCH DM-RS to indicate that it has been able to acquire the COT.

The second network node (e.g. UE) may then determine that the indication has been provided by these transmissions which the first network node has been able to make because it has been able to acquire the COT.

It will also be appreciated that, in some cases a broadcast signal or transmission might be preferred if two or more network nodes will be monitoring an indication in this later frame. For example a direct DCI to only one UE is less likely to be useful if two UEs are monitoring the indication. In this case a group DCI (if a suitable group can be identified) or an implicit indication might be found to be more efficient.

It will also be appreciated that the terminal might be able to detect both an explicit and implicit indicator. As discussed above, depending on the situation and if configured to do so, the base station might opt for an explicit or implicit indication. When the UE is able to detect both types of indication, this will allow the base station to use different types of downlink messages and to select the one deemed most appropriate. For example, if the gNB needs to send a DG-DCI for another purpose it can do so without also using additional resources for an explicit COT Confirmation indicator (which would waste radio resources). Instead, the gNB can perform both tasks (sending the DG-DCI and providing the indication) using a single message that the terminal can detect as an implicit indication, such as an implicit COT Confirmation Indicator.

### Acknowledging the COT Confirmation Indicator

In some cases, the terminal may be configured to confirm that it has detected the indicator. This may for example allow the base station to confirm or adjust power settings and/or Modulation and Coding Schemes (MCS) for sending the indication or other transmissions as well.

According to this technique, the UE can indicate whether it has detected the COT Confirmation Indicator at the start of the gNB's FFP.

In one example, the Indication acknowledgement can be sent as an Uplink Control Information message (UCI) which can be piggybacked onto the scheduled transmission (for example in a manner similar to what is done for CG-UCI).

In an example, the Indication acknowledgement may be provided as a 1-bit indicator indicating whether the UE detected the COT Confirmation Indicator or not. This may be in a UCI message or in another type of uplink control information message.

In an example, the Indication acknowledgement can also indicate whether the UE is transmitting the UL Transmission according to the UE's COT or gNB's COT. As will be appreciated from the discussion above, there may be cases where the UE decided to initiate its own COT (using its FFP configuration) for sending the scheduled transmission, rather than the requested base station FFP configuration. On the other hand, whether the terminal is using its own COT or the base station's may not be easily detectable by the base station, from the scheduled transmission only for example. Accordingly, the base station might adjust its behaviour once it has determined that the terminal is using its own COT.

It might also be noted that in this case, and in cases where the terminal would be expected to use the gNB's COT if the indicator is detected, the base station would also know implicitly whether the UE had detected the COT Confirmation Indicator. Namely, if the UE does transmit the scheduled transmission but also indicates that the transmission is according to the UE's COT, when the base station had indicated to transmit it according to base station's COT, the base station may derive from this that the UE was not able to detect the indication (whether it was actually transmitted or not).

### Operating Methods

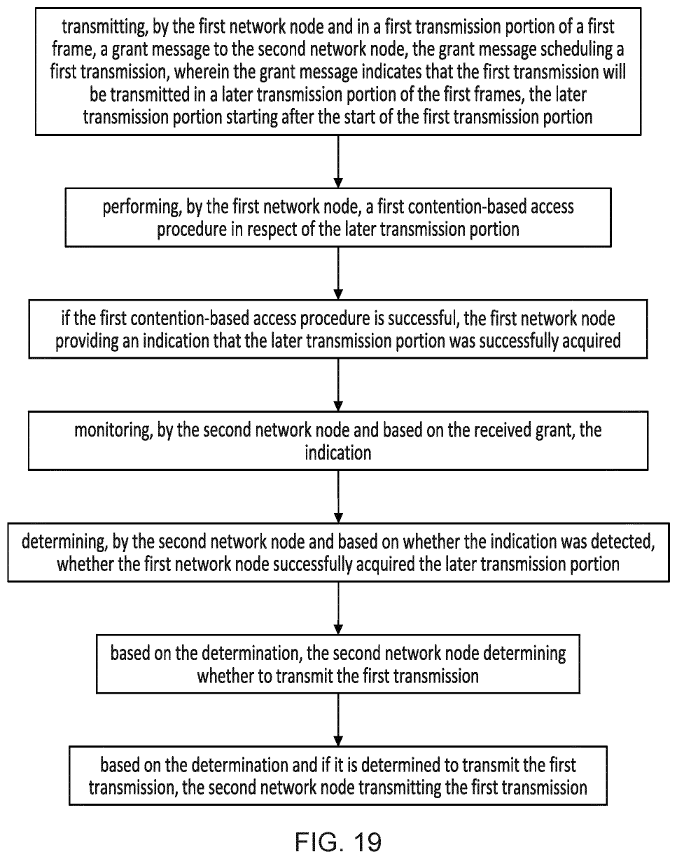

FIG. 19 illustrates method steps in accordance with the present disclosure, where a first network node and a second network node communicating in an unlicensed and contention-based access network operate in accordance with a first and second frame configuration, respectively. The techniques in accordance with this method are expected to reduce the risk of the ambiguity or uncertainty between the first and second network node about whether a transmission should be sent or not.

The first frame configuration comprises or defines a first COT (transmission portion) and a first idle portion (e.g. Idle Period). The second frame configuration comprises or defines a second COT (transmission portion) and a second idle portion (e.g. Idle Period). Said differently, the first and second frame configurations define first and second frames, respectively, with the first and second frames (e.g. with each of the first and second frames) having at least a transmission portion and an idle portion.

First, the first network node transmits in a first frame a grant message to the second network node, the grant message scheduling a first transmission, for example from the second network node to the first network node. The grant message indicates that the first transmission will be transmitted in a later transmission portion of the first frames. Said differently, the first transmission is configured to be transmitted using a transmission portion (e.g. COT) of the first network node, and will be in a later transmission portion (e.g. COT) of the first frames defined by the first frame configuration. Namely, the later transmission portion is a transmission portion starting after the start of the first transmission portion in which the grant message is transmitted.

The first network node then performs a first contention-based access procedure in respect of the later transmission portion, with a view to acquiring the later transmission portion.

If the first contention-based access procedure is successful, the first network node provides an indication that the later transmission portion was successfully acquired.

The second network node monitors, based on the received grant, the indication in the later transmission portion. For example, it may identify the later transmission portion based on the grant and monitor an initial portion of the later transmission portion.

Based on whether the indication was detected, the second network node determines whether the first network node successfully acquired the later transmission portion. For example, if it is detected, it can determine that the first network node successfully acquired the later transmission portion. Additionally or alternatively, if it is not detected, it can determine that the first network node did not acquire the later transmission portion.

Based on this determination, the second network node determines whether to transmit the first transmission. For example, in some cases when the indication is not detected (and possibly based on other conditions), the second network node can determine to cancel the first transmission, that is, it can determine not to transmit the first transmission. In other cases, when the indication is not detected (and possibly based on other conditions), the second network node can determine to transmit the first transmission in the transmission portion of one of the second frames.

Based on the determination and if it is determined to transmit the first transmission, the second network node can transmit the first transmission in the later frame.

For example, providing the indication may comprise providing the indication at the start of a transmission portion of the later transmission portion.

In some cases, the first network node may be a one of a base station, a terminal, a relay node, a CU unit and a DU unit. Likewise, the second network node may be one of a base station, a terminal, a relay node, a CU unit and a DU unit. It will be appreciated that they can also be of the same type, with for example the two network nodes being two terminals. In other words, the method comprises but is not limited to a situation where the first network node is a base station and the second network node is a terminal.

In some cases, transmitting the first transmission may comprise identifying, based on the determination, a transmission portion to transmit the first transmission, the identified transmission portion being one of the later transmission portion of the first frames and a second transmission portion of the second frames; and transmitting the first transmission using the identified transmission portion. For example, the second transmission portion of the second frames may be selected, even if the transmission portion identified in the grant message was a transmission portion of the first frames (the later transmission portion), not of the second frames.

For example, the second network node may identify a second transmission to be sent to the first network node and determine whether sending the second transmission with (e.g. after) the first transmission would result in the second network node transmitting outside of the identified transmission portion. If sending the second transmission with the first transmission would result in the second network node transmitting outside of the identified transmission portion, transmitting the first transmission in the identified transmission portion and not transmitting the second transmission in the identified transmission portion. In some cases, if sending the second transmission with the first transmission would not result in the second network node transmitting outside of the identified transmission portion, transmitting the first transmission and the second transmission in the identified transmission portion.

In some implementations, the second network node may, upon determining that the indication was not detected, determine whether the first transmission overlaps with an idle period of the second frames. If the first transmission overlaps with an idle period of the second frames, the second network node determines not to transmit the first transmission.

In some instances, the second network node may, upon determining that the indication was not detected, select a second transmission portion of the second frames for the transmitting the first transmission. For example, if the second network node is a UE and the transmission portion is a COT, it can select the UE's COT for transmitting the first transmission if the indication was not detected. If it is determined to transmit the first transmission, it can then perform a second contention-based access procedure in respect of the second transmission portion, the second transmission portion comprising the resources for the first transmission; and if the second contention-based access procedure is successful, transmit the first transmission, for example in the second transmission portion (of the second frames).

For example, the second network node may determine, upon determining that the indication was not detected, whether the first transmission is scheduled at the start of the second transmission portion. If the first transmission is scheduled at the start of the second transmission portion, it can determine to transmit the first transmission and if the first transmission is not scheduled at the start of the second transmission portion, it can determine not to transmit the first transmission.

In some examples, the second network node determines, upon determining that the indication was not detected, not to transmit the first transmission.

In some cases, a monitoring mode is configured for the second network node using control signalling, wherein the monitoring mode determines whether the second network node is configured to monitor the indication. Alternatively or additionally, determining whether to transmit the first transmission may comprise determining, based on a configuration received via control signalling, whether to transmit the first transmission using the second frame configuration or to cancel the first transmission.

In such examples, the control signalling may comprise one or more of RRC signalling, system information and downlink control information (DCI) signalling. The control signalling may for example be received from the first network node (or another node) which may be a terminal or a base station of the network.

As discussed above, the first frame may be one of the first frames or one of the second frames. That is, the grant message may be sent in (a transmission portion or a COT of) a frame associated with the first network node (e.g. a gNB's COT), i.e. in one of the first frames, or in (a transmission portion or a COT of) a frame associated with the second network node (e.g. a UE's COT), i.e. in one of the second frames.

As previously noted, in some cases the first frame (in which the grant message is transmitted) is one of the second frames. That is, the grant message is sent in a transmission portion (e.g. COT) of the second network node (e.g. UE in the illustrative examples above). Optionally, the later transmission portion (in which the first transmission is scheduled by the grant message) overlaps in time with the first transmission portion.

As discussed above, providing the indication comprises transmitting a downlink control signal comprising the indication. For example, the downlink control signal may be sent to the second network node or to a plurality of network nodes comprising the second network node.

It is also appreciated that providing the indication may comprises implicitly providing the indication by transmitting in resources in the later frame. For example, the resources in the later frame may be at the start of a transmission portion of the later frame. The resources may also or alternatively be used for one or more of: transmitting downlink control information to at least the second network node and relating to a transmission other than the first transmission; transmitting broadcast information; transmitting broadcast system information; transmitting a synchronisation signal; and transmitting a reference signal.

In some cases, the second network node may, upon detecting the indication, transmit an acknowledgment message to the first network node, the acknowledgement message confirming that the indication has been detected. For example, the acknowledgement message may be transmitted as an uplink control information (UCI) message. Alternatively or additionally, the acknowledgment message may be sent with (or “piggybacked”) the first transmission which is scheduled by the grant message.

As discussed above, the second network node may be configured to identify, based on the determination, a transmission portion to transmit the first transmission, the identified transmission portion being a transmission portion of a selected one of the first frames and of the second frames. For example, it may be configured to use a transmission portion of the second frames when the indication is not detected. Optionally, it may then transmit the first transmission in the identified transmission portion and transmit, with the first transmission and in the identified transmission portion, a frame type identifier, the frame type identifier indicating the selected one of the first frames and of the second frames. For example, the frame type identifier may be “piggybacked” onto the first transmission. For example, in a case where the second network node is a UE and the first network node is a base station, the UE may decide to use its own COT for sending the transmission (e.g. if it has not detected the indication) and may notify the base station (which might have sent the indication that was not detected).

### Further Considerations

As previously briefly mentioned, it will also be appreciated that in some cases the UE will by default monitor the indication when the scheduled transmission is in a gNB's COT which is different from that in which the grant was transmitted, while in other cases this may be a configurable behaviour, where the configuration may be done by control signalling such as RRC signalling. While some examples illustrate a case where the UE is configured to monitor the indication (or not), the teachings provided in respect of these examples regarding the network nodes' respective behaviours will apply equally whether the behaviours are configurable or fixed (e.g. preconfigured or default) behaviours.

As mentioned above, in many examples the scheduled transmission in the future frame is illustrated as scheduled at the start of the UE's FFP boundary but the same principles can apply if the transmission is in another part of the UE's COT or FFP. Scheduling the transmission at the start of the COT can increase flexibility as the terminal can more easily use its own COT if it desires and can therefore have a greater choice of COT to select (e.g. by making a choice between the gNB's COT and its own COT).

However, even in such a case, the transmission might be at a later point in time in the UE's COT. For example and in addition to this first scheduled transmission, the base station (or first network node) may also schedule a second transmission for the UE (or second network node) to transmit, which is before the first transmission and which is scheduled at the start of the COT. In this example, the base station can still schedule the first transmission in the UE's COT, at a time which is not at the start of the COT, while still offering the same flexibility. And it should be noted that the scheduled transmission(s) may also not align with the UE's COT altogether.

It will also be appreciated that in cases where the UE's FFP configuration and/or contention-based access mode of operation may be different from the examples above, the UE may still be able to use its own COT regardless of when the transmission is scheduled. For example, in an arrangement where the UE is allowed to start a COT at any time (e.g. where the FFP configuration can configure at least an IDLE duration and a COT duration, but not necessarily a defined starting time or offset), then the UE would always have the option to use its COT for sending the scheduled transmission and will therefore always have the ambiguity discussed above to address.

It will be appreciated that even though in many examples, the FFP for the grant message and the FFP for the scheduled transmission are consecutive or adjacent ones, the present disclosure is not limited to this. The same principles, limitations and teachings apply equally to cases where the transmission is scheduled in an FFP frame which is after the next FFP frame after the grant message (e.g. DCI) is transmitted. Consecutive FFPs have been used in the illustrative examples only for ease of representation in the Figures.

In the context of the present disclosure, an unlicensed spectrum can be seen as a spectrum where devices using wireless technologies other than the one of the wireless interface (between the mobile node and network node) or using the same wireless technologies but controlled by another operator or network, may operate in the same spectrum. In other words, an unlicensed spectrum can be seen as a spectrum over which the network does not have exclusive rights or access. Accordingly, these other devices will potentially compete for the same resources as the mobile node and network node without the network or mobile nodes being able to predict the utilisation of the unlicensed spectrum by others and thus the level of interference caused by others.

The term resources or resource can refer to any suitable set of time and frequency resources to be used to transmit signals on the wireless interface. This may be measured in some cases based on a unit of resource block, slot, frame or any other resource unit deemed appropriate.

Additionally, the method steps discussed herein may be carried out in any suitable order. For example, steps may be carried out in an order which differs from an order used in the examples discussed above or from an indicative order used anywhere else for listing steps (e.g. in the claims), whenever possible or appropriate. Thus, in some cases, some steps may be carried out in a different order, or simultaneously or in the same order. So long as an order for carrying any of the steps of any method discussed herein is technically feasible, it is explicitly encompassed within the present disclosure.

As used herein, transmitting information or a message to an element may involve sending one or more messages to the element and may involve sending part of the information separately from the rest of the information. The number of “messages” involved may also vary depending on the layer or granularity considered. For example, transmitting a message may involve using several resource elements in an LTE or NR environment such that several signals at a lower layer correspond to a single message at a higher layer. Also, transmissions from one node to another may relate to the transmission of any one or more of user data, system information, control signalling and any other type of information to be transmitted.

Also, whenever an aspect is disclosed in respect of an apparatus or system, the teachings are also disclosed for the corresponding method and for the corresponding computer program. Likewise, whenever an aspect is disclosed in respect of a method, the teachings are also disclosed for any suitable corresponding apparatus or system as well as for the corresponding computer program. Additionally, it is also hereby explicitly disclosed that for any teachings relating to a method or a system where it has not been clearly specified which element or elements are configured to carry out a function or a step, any suitable element or elements that can carry out the function can be configured to carry out this function or step. For example, any one or more of a mobile node or network node may be configured accordingly if appropriate, so long as it is technically feasible and not explicitly excluded.

Whenever the expressions “greater than” or “smaller than” or equivalent are used herein, it is intended that they disclose both alternatives “and equal to” and “and not equal to” unless one alternative is expressly excluded.

It will be appreciated that while the present disclosure has in some respects focused on implementations in a 5G or NR network as such a network is expected to provide the primary use case at present, the same teachings and principles can also be applied to other wireless telecommunications systems. Thus, even though the terminology used herein is generally the same or similar to that of the 5G (or LTE) standards, the teachings are not limited to the present versions of 5G (or LTE) and could apply equally to any appropriate arrangement not based on 5G/LTE, for example any arrangement possibly compliant with any future version of an LTE, 5G or other standard-defined by the 3GPP standardisation groups or by other groups. Accordingly, the teaching provided herein using 3GPP, LTE and/or 5G/NR terminology can be equally applied to other systems with reference to the corresponding functions. For example, references to HARQ-ACK or DCI can be more generally understood as references to acknowledgements (positive or negative) or control information relating to the downlink.

It will be appreciated that the principles described herein are applicable not only to certain types of communications device, but can be applied more generally in respect of any types of communications device. For example while the techniques are expected to be particularly useful for systems using NR-U communications, the skilled person will appreciate that they can also be applied more generally, for example in respect of any type of communications device operating with a wireless link to the communication network, or for peer-to-peer transmissions (either transmissions ending at another node of the radio access network, e.g. a communication device or any other type of node in the network, or transmissions to or from the main or core network and going through a mesh network in the radio access network).

It is noteworthy that where a “predetermined” element is mentioned, it will be appreciated that this can include for example a configurable element, wherein the configuration can be done by any combination of a manual configuration by a user or administrator or a transmitted communication, for example from the network or from a service provider (e.g. a device manufacturer, an OS provider, etc.).

Techniques discussed herein can be implemented using a computer program product, comprising for example computer-readable instructions stored on a computer readable medium which can be executed by a computer, for carrying out a method according to the present disclosure. Such a computer readable medium may be a non-transitory computer-readable storage medium with an executable program stored thereon, wherein the program instructs a microprocessor to perform said method. Additionally, or alternatively, the techniques discussed herein may be realised at least in part by a computer readable communication medium that carries or communicates code in the form of instructions or data structures and that can be accessed, read, and/or executed by a computer.

In other words, any suitable computer readable medium may be used, which comprises instructions and which can for example be a transitory medium, such as a communication medium, or a non-transitory medium, such as a storage medium. Accordingly, a computer program product may be a non-transitory computer program product.

Further particular and preferred aspects of the present invention are set out in the accompanying independent and dependent claims. It will be appreciated that features of the dependent claims may be combined with features of the independent claims in combinations other than those explicitly set out in the claims.

Thus, the foregoing discussion discloses and describes merely examples of the present invention. As will be understood by those skilled in the art, the present invention may be embodied in other specific forms without departing from the spirit or essential characteristics thereof. Accordingly, the disclosure of the present invention is intended to be illustrative, but not limiting of the scope of the invention, as well as other claims. The disclosure, including any readily discernible variants of the teachings herein, define, in part, the scope of the foregoing claim terminology such that no inventive subject matter is dedicated to the public.

Respective features of the present disclosure are defined by the following numbered clauses:

Clause 1. A method for communicating in a mobile telecommunications network, the network comprising at least a first network node configured to communicate via a wireless interface with a second network node, wherein the wireless interface comprises a first frequency band in which access to resources in the frequency band is a contention-based access, wherein the first network node is configured with a first frame configuration and wherein the second network node is configured with a second frame configuration, the first frame configuration defining first frames having a transmission portion and an idle portion and the second frame configuration defining second frames having a transmission portion and an idle portion, the method comprising:
transmitting, by the first network node and in a first transmission portion of a first frame, a grant message to the second network node, the grant message scheduling a first transmission, wherein the grant message indicates that the first transmission will be transmitted in a later transmission portion of the first frames, the later transmission portion starting after the start of the first transmission portion; performing, by the first network node, a first contention-based access procedure in respect of the later transmission portion;
if the first contention-based access procedure is successful, the first network node providing an indication that the later transmission portion was successfully acquired;
monitoring, by the second network node and based on the received grant, the indication; and
determining, by the second network node and based on whether the indication was detected, whether the first network node successfully acquired the later transmission portion and, based on the determination, the second network node:
determining whether to transmit the first transmission; and
if it is determined to transmit the first transmission, transmitting the first transmission.

Clause 2. The method of Clause 1 wherein:
the first network node is one of a base station, a terminal, a relay node, a CU unit and a DU unit; and/or
the second network node is one of a base station, a terminal, a relay node, a CU unit and a DU unit.

Clause 3. The method of Clause 1 or 2, wherein the first network node is a base station and the second network node is a terminal.

Clause 4. The method of any preceding Clause, wherein transmitting the first transmission comprises
identifying, based on the determination, a transmission portion to transmit the first transmission, the identified transmission portion being one of the later transmission portion of the first frames and a second transmission portion of the second frames; and
transmitting the first transmission according to the identified transmission portion.

Clause 5. The method of Clause 4, further comprising the second network node:
identifying, a second transmission to be sent to the first network node;
determining whether sending the second transmission with the first transmission would result in the second network node transmitting outside of the identified transmission portion; and
if sending the second transmission with the first transmission would result in the second network node transmitting outside of the identified transmission portion, transmitting the first transmission in the identified transmission portion and not transmitting the second transmission in the identified transmission portion.

Clause 6. The method of Clause 5 further comprising:
if sending the second transmission with the first transmission would not result in the second network node transmitting outside of the identified transmission portion, transmitting the first transmission and the second transmission in the identified transmission portion.

Clause 7. The method of any preceding Clause, further comprising the second network node:
upon determining that the indication was not detected, determining whether the first transmission overlaps with an idle period of the second frames; and
if the first transmission overlaps with an idle period of the second frames, determining not to transmit the first transmission.

Clause 8. The method of any preceding Clause, further comprising the second network node:
upon determining that the indication was not detected, selecting a second transmission portion of the second frames for the transmitting the first transmission; and
if it is determined to transmit the first transmission:
performing a second contention-based access procedure in respect of the second transmission portion, the second transmission portion comprising the resources for the first transmission; and
if the second contention-based access procedure is successful, transmitting the first transmission, wherein transmitting the first transmission comprises transmitting the first transmission in the second transmission portion.

Clause 9. The method of Clause 8 further comprising the second network node:
upon determining that the indication was not detected, determining whether the first transmission is scheduled at the start of the second transmission portion,
if the first transmission is scheduled at the start of the second transmission portion, determining to transmit the first transmission; and
if the first transmission is not scheduled at the start of the second transmission portion, determining not to transmit the first transmission.

Clause 10. The method of any preceding Clause, further comprising the second network node upon determining that the indication was not detected, determining not to transmit the first transmission.

Clause 11. The method of any preceding Clause wherein a monitoring mode is configured for the second network node using control signalling, the monitoring mode determining whether the second network node is configured to monitor the indication.

Clause 12. The method of any preceding Clause wherein determining, when the indication is not detected, whether to transmit the first transmission comprises determining, based on a configuration received via control signalling, whether to transmit the first transmission in a second transmission portion of the second frame or to cancel the first transmission.

Clause 13. The method of Clause 11 or 12 wherein the control signalling comprises one or more of RRC signalling, system information and downlink control information (DCI) signalling.

Clause 14. The method of any preceding Clause wherein the first frame is one of the first frames or one of the second frames.

Clause 15. The method of any preceding Clause wherein the first frame is one of the second frames and wherein the later transmission portion overlaps in time with the first transmission portion.

Clause 16. The method of any preceding Clause, wherein providing the indication comprises transmitting a downlink control signal comprising the indication.

Clause 17. The method of Clause 16, wherein the downlink control signal is sent to the second network node or to a plurality of network nodes comprising the second network node.

Clause 18. The method of any preceding Clause wherein providing the indication comprises implicitly providing the indication by transmitting in resources in the later transmission portion.

Clause 19. The method of Clause 18, wherein the resources in the later transmission portion are at the start of a transmission portion of the later transmission portion.

Clause 20. The method of Clause 18 or 19, wherein the resources are used for one or more of:
transmitting downlink control information to at least the second network node and relating to a transmission other than the first transmission;
transmitting broadcast information;
transmitting broadcast system information;
transmitting a synchronisation signal; and
transmitting a reference signal.

Clause 21. The method of any preceding Clause, wherein providing the indication comprises providing the indication at the start of a transmission portion of the later frame.

Clause 22. The method of any preceding Clause further comprising the second network node, upon detecting the indication, transmitting an acknowledgment message to the first network node, the acknowledgement message confirming that the indication has been detected.

Clause 23. The method of any preceding Clause further comprising the second network node:
identifying, based on the determination, a transmission portion to transmit the first transmission, the identified transmission portion being a transmission portion of a selected one of the first frames and of the second frames;
transmitting the first transmission in the identified transmission portion; and
transmitting, with the first transmission and in the identified transmission portion, a frame type identifier, the frame type identifier indicating the selected one of the first frames and of the second frames.

Clause 24. A system for use in a mobile telecommunications network, the system comprising at least a first network node and a second network node, the first network node being configured to communicate via a wireless interface with the second network node, wherein the wireless interface comprises a first frequency band in which access to resources in the frequency band is a contention-based access, wherein the first network node is configured with a first frame configuration and wherein the second network node is configured with a second frame configuration, the first frame configuration defining first frames having a transmission portion and an idle portion and the second frame configuration defining second frames having a transmission portion and an idle portion,
wherein the first network node is configured to:
transmit, in a first transmission portion of a first frame, a grant message to the second network node, the grant message scheduling a first transmission, wherein the grant message indicates that the first transmission will be transmitted in a later transmission portion of the first frames, the later transmission portion starting after the start of the first transmission portion;
perform a contention-based access procedure in respect of the later transmission portion; and
if the contention-based access procedure is successful, provide an indication that the later transmission portion was successfully acquired.
wherein the second network node is configured to:
receive, from the first network node and in a first frame, a grant message, the grant message scheduling a first transmission, wherein the grant message indicates that the first transmission will be transmitted in a later transmission portion of the first frames, the later transmission portion starting after the start of the first transmission portion;
monitor, based on the received grant, an indication in the later frame; and
determine, based on whether the indication was detected, whether the first network node successfully acquired the later transmission portion and, based on the determination:
determine whether to transmit the first transmission; and
if it is determined to transmit the first transmission, transmit the first transmission.

Clause 25. A method of operating a first network node in a mobile telecommunications network, the network comprising at least the first network node being configured to communicate via a wireless interface with a second network node of the network, wherein the wireless interface comprises a first frequency band in which access to resources in the frequency band is a contention-based access, wherein the first network node is configured with a first frame configuration and wherein the second network node is configured with a second frame configuration, the first frame configuration defining first frames having a transmission portion and an idle portion and the second frame configuration defining second frames having a transmission portion and an idle portion, the method comprising the first network node: transmitting, in a first transmission portion of a first frame, a grant message to the second network node, the grant message scheduling a first transmission, wherein the grant message indicates that the first transmission will be transmitted in a later transmission portion of the first frames, the later transmission portion starting after the start of the first transmission portion;
performing a contention-based access procedure in respect of the later transmission portion; and
if the contention-based access procedure is successful, providing an indication that the later transmission portion was successfully acquired.

Clause 26. The method of Clause 25, the method further comprising configuring a monitoring mode for the second network node using control signalling, the monitoring mode determining whether the second network node is configured to monitor the indication.

Clause 27. The method of Clause 25 or 26, further comprising configuring the second network node to transmit the first transmission in a second transmission portion of the second frame or to cancel the first transmission when the indication is not detected, based on a configuration transmitted to the second network node via control signalling.

Clause 28. The method of Clause 26 or 27 wherein the control signalling comprises one or more of RRC signalling, system information and downlink control information (DCI) signalling.

Clause 29. The method of any one of Clauses 25 to 28, wherein providing the indication comprises transmitting a downlink control signal comprising the indication.

Clause 30. The method of Clause 29, wherein the downlink control signal is sent to the second network node or to a plurality of network nodes comprising the second network node.

Clause 31. The method of any one of Clauses 25 to 30, wherein providing the indication comprises implicitly providing the indication by transmitting in resources in the later transmission portion.

Clause 32. The method of Clause 31, wherein the resources in the later transmission portion are at the start of a transmission portion of the later transmission portion.

Clause 33. The method of Clause 31 or 32, wherein the resources are used for one or more of:
transmitting downlink control information to at least the second network node and relating to a transmission other than the first transmission;
transmitting broadcast information;
transmitting broadcast system information;
transmitting a synchronisation signal; and
transmitting a reference signal.

Clause 34. The method of any one of Clauses 25 to 33, wherein providing the indication comprises providing the indication at the start of a transmission portion of the later frame.

Clause 35. The method of any one of Clauses 25 to 34, further comprising:
receiving, with the first transmission and in the identified transmission portion, a frame type identifier, the frame type identifier indicating a selected one of the first frames and of the second frames used by the second network node for sending the first transmission.

Clause 36. A network node for use in a mobile telecommunications network, the network comprising at least the network node being configured to communicate via a wireless interface with a second network node of the network, wherein the wireless interface comprises a first frequency band in which access to resources in the frequency band is a contention-based access, wherein the network node is configured with a first frame configuration and wherein the second network node is configured with a second frame configuration, the first frame configuration defining first frames having a transmission portion and an idle portion and the second frame configuration defining second frames having a transmission portion and an idle portion, network node being configured to:
transmit, in a first transmission portion of a first frame, a grant message to the second network node, the grant message scheduling a first transmission, wherein the grant message indicates that the first transmission will be transmitted in a later transmission portion of the first frames, the later transmission portion starting after the start of the first transmission portion;
perform a contention-based access procedure in respect of the later transmission portion; and
if the contention-based access procedure is successful, provide an indication that the later transmission portion was successfully acquired.

Clause 37. The network node of Clause 36, the network node being configured to implement the method of any one of Clauses 25 to 35.

Clause 38. Circuitry for a network node in a mobile telecommunications network, wherein the circuitry comprises a controller element and a transceiver element configured to operate together to communicate via a wireless interface with a second network node of the network, wherein the wireless interface comprises a first frequency band in which access to resources in the frequency band is a contention-based access, wherein the network node is configured with a first frame configuration and wherein the second network node is configured with a second frame configuration, the first frame configuration defining first frames having a transmission portion and an idle portion and the second frame configuration defining second frames having a transmission portion and an idle portion, and wherein the controller element and the transceiver element are further configured to operate together to:
transmit, in a first transmission portion of a first frame, a grant message to the second network node, the grant message scheduling a first transmission, wherein the grant message indicates that the first transmission will be transmitted in a later transmission portion of the first frames, the later transmission portion starting after the start of the first transmission portion;
perform a contention-based access procedure in respect of the later transmission portion; and
if the contention-based access procedure is successful, provide an indication that the later transmission portion was successfully acquired.

Clause 39. The circuitry of Clause 38, wherein the controller element and the transceiver element are further configured to operate together to implement the method of any one of Clauses 25 to 35.

Clause 40. A method of operating a network node in a mobile telecommunications network, the network comprising at least a first network node and the network node as a second network node of the network, wherein the first network node is configured to communicate via a wireless interface with the second network node, wherein the wireless interface comprises a first frequency band in which access to resources in the frequency band is a contention-based access, wherein the first network node is configured with a first frame configuration and wherein the second network node is configured with a second frame configuration, the first frame configuration defining first frames having a transmission portion and an idle portion and the second frame configuration defining second frames having a transmission portion and an idle portion, the method comprising the second network node:
receiving, from the first network node and in a first frame, a grant message, the grant message scheduling a first transmission, wherein the grant message indicates that the first transmission will be transmitted in a later transmission portion of the first frames, the later transmission portion starting after the start of the first transmission portion;
monitoring, based on the received grant, an indication in the later frame; and
determining, based on whether the indication was detected, whether the first network node successfully acquired the later transmission portion and, based on the determination, the second network node:
determining whether to transmit the first transmission; and
if it is determined to transmit the first transmission, transmitting the first transmission.

Clause 41. The method of Clause 40, wherein transmitting the first transmission comprises identifying, based on the determination, a transmission portion to transmit the first transmission, the identified transmission portion being one of the later transmission portion of the first frames and a second transmission portion of the second frames; and transmitting the first transmission according to the identified transmission portion.

Clause 42. The method of Clause 41, further comprising the second network node:
identifying, a second transmission to be sent to the first network node;
determining whether sending the second transmission with the first transmission would result in the second network node transmitting outside of the identified transmission portion; and
if sending the second transmission with the first transmission would result in the second network node transmitting outside of the identified transmission portion, transmitting the first transmission in the identified transmission portion and not transmitting the second transmission in the identified transmission portion.

Clause 43. The method of Clause 42 further comprising:
if sending the second transmission with the first transmission would not result in the second network node transmitting outside of the identified transmission portion, transmitting the first transmission and the second transmission in the identified transmission portion.

Clause 44. The method of any one of Clauses 40 to 43, further comprising:
upon determining that the indication was not detected, determining whether the first transmission overlaps with an idle period of the second frames; and
if the first transmission overlaps with an idle period of the second frames, determining not to transmit the first transmission.

Clause 45. The method of any one of Clauses 40 to 44, further comprising:
upon determining that the indication was not detected, selecting a second transmission portion of the second frames for the transmitting the first transmission; and
if it is determined to transmit the first transmission:
performing a second contention-based access procedure in respect of the second transmission portion, the second transmission portion comprising the resources for the first transmission; and
if the second contention-based access procedure is successful, transmitting the first transmission, wherein transmitting the first transmission comprises transmitting the first transmission in the second transmission portion.

Clause 46. The method of Clause 45 further comprising:
upon determining that the indication was not detected, determining whether the first transmission is scheduled at the start of the second transmission portion,
if the first transmission is scheduled at the start of the second transmission portion, determining to transmit the first transmission; and
if the first transmission is not scheduled at the start of the second transmission portion, determining not to transmit the first transmission.

Clause 47. The method of any one of Clauses 40 to 46, further comprising upon determining that the indication was not detected, determining not to transmit the first transmission.

Clause 48. The method of any one of Clauses 40 to 47, wherein a monitoring mode is configured for the second network node using control signalling, the monitoring mode determining whether the second network node is configured to monitor the indication.

Clause 49. The method of any one of Clauses 40 to 48, wherein determining, when the indication is not detected, whether to transmit the first transmission comprises determining, based on a configuration received via control signalling, whether to transmit the first transmission in a second transmission portion of the second frame or to cancel the first transmission.

Clause 50. The method of Clause 48 or 49 wherein the control signalling comprises one or more of RRC signalling, system information and downlink control information (DCI) signalling.

Clause 51. The method of any one of Clauses 40 to 50, wherein the indication is comprised in a downlink control signal.

Clause 52. The method of Clause 51, wherein the downlink control signal is sent to the second network node or to a plurality of network nodes comprising the second network node.

Clause 53. The method of any one of Clauses 40 to 52, wherein the indication is implicitly providing the indication by a transmission in resources in the later transmission portion.

Clause 54. The method of Clause 53, wherein the resources in the later transmission portion are at the start of a transmission portion of the later transmission portion.

Clause 55. The method of any one of Clauses 40 to 54, wherein the indication is provided at the start of a transmission portion of the later frame.

Clause 56. The method of any one of Clauses 40 to 55, further comprising, upon detecting the indication, transmitting an acknowledgment message to the first network node, the acknowledgement message confirming that the indication has been detected.

Clause 57. The method of any one of Clauses 40 to 56, further comprising:
identifying, based on the determination, a transmission portion to transmit the first transmission, the identified transmission portion being a transmission portion of a selected one of the first frames and of the second frames;
transmitting the first transmission in the identified transmission portion; and
transmitting, with the first transmission and in the identified transmission portion, a frame type identifier, the frame type identifier indicating the selected one of the first frames and of the second frames.

Clause 58. A network node for use in a mobile telecommunications network, the network comprising at least a first network node and the network node, wherein the first network node is configured to communicate via a wireless interface with the network node, wherein the wireless interface comprises a first frequency band in which access to resources in the frequency band is a contention-based access, wherein the first network node is configured with a first frame configuration and wherein the network node is configured with a second frame configuration, the first frame configuration defining first frames having a transmission portion and an idle portion and the second frame configuration defining second frames having a transmission portion and an idle portion, the network node being configured to: receive, from the first network node and in a first frame, a grant message, the grant message scheduling a first transmission, wherein the grant message indicates that the first transmission will be transmitted in a later transmission portion of the first frames, the later transmission portion starting after the start of the first transmission portion;
monitor, based on the received grant, an indication in the later frame; and
determine, based on whether the indication was detected, whether the first network node successfully acquired the later transmission portion and, based on the determination:
determine whether to transmit the first transmission; and if it is determined to transmit the first transmission, transmit the first transmission.

Clause 59. The network node of Clause 58, the network node being configured to implement the method of any one of Clauses 40 to 57.

Clause 60. Circuitry for a network node in a mobile telecommunications network, the network comprising at least a first network node and the network node, wherein the first network node is configured to communicate via a wireless interface with the network node, wherein the wireless interface comprises a first frequency band in which access to resources in the frequency band is a contention-based access, wherein the circuitry comprises a controller element and a transceiver element configured to operate together to communicate via the wireless interface,
wherein the first network node is configured with a first frame configuration and wherein the network node is configured with a second frame configuration, the first frame configuration defining first frames having a transmission portion and an idle portion and the second frame configuration defining second frames having a transmission portion and an idle portion, and wherein the controller element and the transceiver element are further configured to operate together to:
transmit, in a first transmission portion of a first frame, a grant message to the second network node, the grant message scheduling a first transmission, wherein the grant message indicates that the first transmission will be transmitted in a later transmission portion of the first frames, the later transmission portion starting after the start of the first transmission portion;
perform a contention-based access procedure in respect of the later transmission portion; and
if the contention-based access procedure is successful, provide an indication that the later transmission portion was successfully acquired.

Clause 61. The circuitry of Clause 60, wherein the controller element and the transceiver element are further configured to operate together to implement the method of any one of claims 40 to 57.

### REFERENCES

[1] 3GPP document RP-160671, “New SID Proposal: Study on New Radio Access Technology,” NTT DOCOMO, RAN #71, Gothenburg, Sweden, 7 to 10 Mar. 2016
[2] 3GPP document RP-172834, “Work Item on New Radio (NR) Access Technology,” NTT DOCOMO, RAN #78, Lisbon, Portugal, 18 to 21 Dec. 2017
[3] 3GPP document RP-182089, “New SID on Physical Layer Enhancements for NR Ultra-Reliable and Low Latency Communication (URLLC),” Huawei, HiSilicon, Nokia, Nokia Shanghai Bell, RAN #81, Gold Coast, Australia, 10 to 13 Sep. 2018
[4] 3GPP document RP-190654, “New WID: Physical layer enhancements for NR ultra-reliable and low latency communication (URLLC),” Huawei, HiSilicon, RAN #83, Shenzhen, China, 18 to 21 Mar. 2019
[5] TR38.913, “Study on Scenarios and Requirements for Next Generation Access Technologies (Release 14)”, v14.3.0
[6] RP-190726, “Physical layer enhancements for NR ultra-reliable and low latency communication (URLLC),” Huawei, HiSilicon, RAN #83
[7] RP-193233, “Enhanced Industrial Internet of Things (IoT) and URLLC support,” Nokia, Nokia Shanghai Bell, RAN #86
[8] RP-191575, “NR-based Access to Unlicensed Spectrum,” Qualcomm, RAN #84
[9] Holma H. and Toskala A, “LTE for UMTS OFDMA and SC-FDMA based radio access”, John Wiley and Sons, 2009
[10] R1-2007391, “Summary #5 on enhancements for unlicensed band URLLC/IIoT for R17,” Moderator (Ericsson), RAN1 #102e

1. A method for communicating in a mobile telecommunications network, the network comprising at least a first network node configured to communicate via a wireless interface with a second network node, wherein the wireless interface comprises a first frequency band in which access to resources in the frequency band is a contention-based access, wherein the first network node is configured with a first frame configuration and wherein the second network node is configured with a second frame configuration, the first frame configuration defining first frames having a transmission portion and an idle portion and the second frame configuration defining second frames having a transmission portion and an idle portion, the method comprising:
transmitting, by the first network node and in a first transmission portion of a first frame, a grant message to the second network node, the grant message scheduling a first transmission, wherein the grant message indicates that the first transmission will be transmitted in a later transmission portion of the first frames, the later transmission portion starting after the start of the first transmission portion:
performing, by the first network node, a first contention-based access procedure in respect of the later transmission portion:
if the first contention-based access procedure is successful, the first network node providing an indication that the later transmission portion was successfully acquired:
monitoring, by the second network node and based on the received grant, the indication; and
determining, by the second network node and based on whether the indication was detected, whether the first network node successfully acquired the later transmission portion and, based on the determination, the second network node:
determining whether to transmit the first transmission; and
if it is determined to transmit the first transmission, transmitting the first transmission.

2. The method of claim 1 wherein:
the first network node is one of a base station, a terminal, a relay node, a CU unit and a DU unit; and/or
the second network node is one of a base station, a terminal, a relay node, a CU unit and a DU unit.

3. The method of claim 1, wherein the first network node is a base station and the second network node is a terminal.

4. The method of claim 1, wherein transmitting the first transmission comprises
identifying, based on the determination, a transmission portion to transmit the first transmission, the identified transmission portion being one of the later transmission portion of the first frames and a second transmission portion of the second frames; and
transmitting the first transmission according to the identified transmission portion.

5. The method of claim 0, further comprising the second network node:
identifying, a second transmission to be sent to the first network node:
determining whether sending the second transmission with the first transmission would result in the second network node transmitting outside of the identified transmission portion; and
if sending the second transmission with the first transmission would result in the second network node transmitting outside of the identified transmission portion, transmitting the first transmission in the identified transmission portion and not transmitting the second transmission in the identified transmission portion.

6. The method of claim 1, further comprising the second network node:
upon determining that the indication was not detected, determining whether the first transmission overlaps with an idle period of the second frames; and
if the first transmission overlaps with an idle period of the second frames, determining not to transmit the first transmission.

7. The method of claim 1, further comprising the second network node:
upon determining that the indication was not detected, selecting a second transmission portion of the second frames for the transmitting the first transmission; and
if it is determined to transmit the first transmission:
performing a second contention-based access procedure in respect of the second transmission portion, the second transmission portion comprising the resources for the first transmission; and
if the second contention-based access procedure is successful, transmitting the first transmission,
wherein transmitting the first transmission comprises transmitting the first transmission in the second transmission portion.

8. The method of claim 0 further comprising the second network node:
upon determining that the indication was not detected, determining whether the first transmission is scheduled at the start of the second transmission portion,
if the first transmission is scheduled at the start of the second transmission portion, determining to transmit the first transmission; and
if the first transmission is not scheduled at the start of the second transmission portion, determining not to transmit the first transmission.

9. The method of claim 1, further comprising the second network node upon determining that the indication was not detected, determining not to transmit the first transmission.

10. The method of claim 1 wherein a monitoring mode is configured for the second network node using control signalling, the monitoring mode determining whether the second network node is configured to monitor the indication.

11. The method of claim 1 wherein determining, when the indication is not detected, whether to transmit the first transmission comprises determining, based on a configuration received via control signalling, whether to transmit the first transmission in a second transmission portion of the second frame or to cancel the first transmission.

12. The method of claim 0 wherein the control signalling comprises one or more of RRC signalling, system information and downlink control information (DCI) signalling.

13. The method of claim 1, wherein providing the indication comprises transmitting a downlink control signal comprising the indication.

14. The method of claim 1 wherein providing the indication comprises implicitly providing the indication by transmitting in resources in the later transmission portion.

15. The method of claim 0, wherein the resources are used for one or more of:
transmitting downlink control information to at least the second network node and relating to a transmission other than the first transmission;
transmitting broadcast information:
transmitting broadcast system information:
transmitting a synchronisation signal; and
transmitting a reference signal.

16. A system for use in a mobile telecommunications network, the system comprising at least a first network node and a second network node, the first network node being configured to communicate via a wireless interface with the second network node, wherein the wireless interface comprises a first frequency band in which access to resources in the frequency band is a contention-based access, wherein the first network node is configured with a first frame configuration and wherein the second network node is configured with a second frame configuration, the first frame configuration defining first frames having a transmission portion and an idle portion and the second frame configuration defining second frames having a transmission portion and an idle portion,
wherein the first network node is configured to:
transmit, in a first transmission portion of a first frame, a grant message to the second network node, the grant message scheduling a first transmission, wherein the grant message indicates that the first transmission will be transmitted in a later transmission portion of the first frames, the later transmission portion starting after the start of the first transmission portion:
perform a contention-based access procedure in respect of the later transmission portion; and
if the contention-based access procedure is successful, provide an indication that the later transmission portion was successfully acquired,
wherein the second network node is configured to:
receive, from the first network node and in a first frame, a grant message, the grant message scheduling a first transmission, wherein the grant message indicates that the first transmission will be transmitted in a later transmission portion of the first frames, the later transmission portion starting after the start of the first transmission portion;
monitor, based on the received grant, an indication in the later frame; and
determine, based on whether the indication was detected, whether the first network node successfully acquired the later transmission portion and, based on the determination:
determine whether to transmit the first transmission; and
if it is determined to transmit the first transmission, transmit the first transmission.

17. (canceled)

18. A network node for use in a mobile telecommunications network, the network comprising at least the network node being configured to communicate via a wireless interface with a second network node of the network, wherein the wireless interface comprises a first frequency band in which access to resources in the frequency band is a contention-based access, wherein the network node is configured with a first frame configuration and wherein the second network node is configured with a second frame configuration, the first frame configuration defining first frames having a transmission portion and an idle portion and the second frame configuration defining second frames having a transmission portion and an idle portion, network node being configured to:
transmit, in a first transmission portion of a first frame, a grant message to the second network node, the grant message scheduling a first transmission, wherein the grant message indicates that the first transmission will be transmitted in a later transmission portion of the first frames, the later transmission portion starting after the start of the first transmission portion;
perform a contention-based access procedure in respect of the later transmission portion; and
if the contention-based access procedure is successful, provide an indication that the later transmission portion was successfully acquired.

19.-22. (canceled)
